(19) United States
(12) Patent Application Publication
(10) Pub. No.: US 2005/0249139 A1
(43) Pub. Date: Nov. 10, 2005

(54) System to deliver internet media streams, data & telecommunications

(76) Inventor: Peter Nesbit, Essendon (AU)

Correspondence Address: The Halvorson Law Firm, Ste 130, 1757 E. Baseline Rd., Gilbert, AZ, 85233, US

(21) Appl. No.: 11/070,195

(22) Filed: Mar. 2, 2005

Related U.S. Application Data
(63) Continuation of application No. PCT/AU03/00725, filed on Oct. 31, 2002.

(30) Foreign Application Priority Data
Sep. 5, 2002 (AU) 2002301467
Sep. 5, 2002 (AU) 20023952575
Apr. 9, 2003 (AU) 2003203591

(51) Int. Cl. H04B 7/00

(52) U.S. Cl. 370/312

(57) ABSTRACT

A system for delivering broadcast and communications services, wherein said services comprise provision of one or more Internet media streams; the system comprising one or more gateways which provide connections to external communications networks and nodes and internal loopbacks from which said services are obtained, each of said gateways comprising: a selection system to selectively establish communication channels with said external communication nodes networks and said loopbacks to establish an individual bidirectional channel between each node network and allow recipients to obtain the communication channel of their choice; a processing system comprising non-blocking matrix switching or routing system, buffering, packeting, and addressing systems; processing said channels containing services into digitized packaged data format and said addressing systems identifying, storing and updating the location of each recipient, and applying routing information to each packet of digitized packaged data to enable packets to be correctly routed through the system.

This application is a continuation of pending PCT application serial no. PCT/AU03/000725 filed on Oct. 31, 2002, which was a continuation of Australian patent application serial no. 2002301467, which was filed on Sep. 5, 2002; Australian patent application serial no. 20023952575, which was filed on Sep. 5, 2002; and Australian patent application serial no. 2003203591, which was filed on Apr. 9, 2003.

### BACKGROUND TO THE INVENTION

Free-to-Air Radio Broadcasting

Most people listen to radio broadcast stations at some time during the day. This may occur in the car, a commuter vehicle, at work, at home on fixed or portable receivers, and in recreational areas. Although most radio stations originally transmitted in the amplitude modulated (AM) broadcast band, many have migrated to the frequency modulated (FM) broadcast band, due to the better audio quality. Unfortunately, their wide bandwidth limits the number of FM stations able to be accommodated in any one area. In capital cities one typically finds about 30-35 stations, most of which provide a reasonable quality of service. Although more channels are available, it is difficult to allocate them without reducing the quality of service, unless transmission ranges are strictly limited.

This shortage of channels has pushed the cost of commercial FM licenses well beyond the means of most aspirants, and often approaches or exceeds a hundred million dollars. Unfortunately, the need to recover such high costs and remain in business makes it risky to experiment with non-mainstream formats. Consequently there is little variety amongst most commercial FM stations, which have tended to become less diverse through mergers and networking. Although more variety is found amongst community broadcasters and lower power FM stations, licenses are few and rarely traded. Furthermore, low power FM stations can be difficult to receive, especially on common indoor receivers using whip antennas.

The remaining outlet for niche broadcasting comprises low power open narrowcast (LPON) FM stations, which in metropolitan areas are commonly limited to 1 watt output and a 5 km range. With many such stations typically scattered around metropolitan areas and a high level of frequency re-use, service areas are limited and interference is often severe. Except for special stations established to serve listeners in a single area, such as a sports venue, most LPON stations are unable to satisfy more than a fraction of their potential audience at any one time.

Internet Radio Broadcasting

Internet radio has grown strongly in recent times, and is poised to become the broadcasting medium of the future. Anyone can set up and operate an Internet radio station, at a much lower cost than a free-to-air radio station. Because they do not use scarce radio spectrum, there is no limit to the number of such stations that can simultaneously operate.

Unlike free-to-air stations, Internet stations have worldwide range. Those on the far side of the world can be heard just as clearly as those operating locally. This makes available a huge variety of programming and music styles. Unfortunately, Internet broadcasting has limitations, which unless resolved, will continue to limit its mainstream acceptance, for example:
(a) most people still connect to the web using dial up modems, which due to limited speed, cause poor audio quality and buffering. Although cable modems and ADSL connections usually resolve these problems, they are considerably more expensive to install and use;
(b) many Internet service providers charge according to the amount of time connected and/or amount of data downloaded, inhibiting long periods of listening to Internet radio. Furthermore, few people want to tie up their telephone line or computer for long periods to listen to radio;
(c) unlisted stations are hard to find, URLs are complicated to enter, and it can be difficult to maintain a reliable connection;
(d) computers are often located away from living areas, making Internet radio less practical when working or moving around the house;
(e) computers lack the ergonomic advantages of traditional radio receivers;
(f) Internet radio is not economically available in vehicles, where much listening takes place.

Television

Despite general agreement that the existing free-to-air system needs updating, impediments to adoption have included controversies over technical standards, high station upgrade costs, and the natural reluctance of consumers to replace their existing television receiver without good reason, which for many is an expensive asset. As for Internet television, existing network limitations make it hard enough to get real-time video of limited quality in a window on a computer monitor, let alone high quality video on a full size television screen. The Internet equivalent of high definition television is even further away.

Telephony

For the mobile telephone service, problems include limited coverage outside metropolitan areas, community concern over telephone towers, complex charging schemes, and relatively high call costs. For the fixed telephone service, concerns are often voiced relating to rural areas, mainly poor line quality and reliability, low Internet data rates, and limited geographical penetration.

Summary

Technological developments in the broadcasting and telecommunications industries are predominantly driven by private cooperate goals, rather than a shared perception of the ‘grass-roots’ public need. Because these goals differ from one company to the next, there is no clear and compelling direction for the industry as a whole. This results in a plethora of products, none of which satisfy the real needs of the public, and also much wasted research and development effort.

It is also evident that a significant mismatch exists between the known public demand for more diverse radio broadcasting, and what the broadcasting industry is prepared to offer (or can offer, given the limited number of frequencies available for radio broadcasting).

These factors drove the development of the system disclosed herein, which represents a radical departure from the accepted evolutionary model of technological development. The system disclosed fulfills the public need as stated above, in that it opens the door to unlimited diversity in radio and TV broadcasting (through the medium of Internet radio and Internet TV), it is easy for an untrained person to use, and it can deliver Internet radio and TV, telecommunications and data services to fixed, vehicle and portable recipients in any location from the city center to deep rural, and even onboard aircraft.

### SUMMARY OF THE INVENTION

In accordance with the invention there is provided a system for delivering broadcast and communications services through connection means to fixed, vehicular and portable recipients, wherein said services include provision of one or more Internet media streams including Internet audio streams and Internet video streams, Internet data including the world-wide-web and email, and telecommunications; the system including one or more gateways which provide connections to external communications networks and nodes and internal loopbacks from which said services are obtained, each of said one or more gateways including:
(a) selection means to selectively establish communication channels with said external communication nodes networks and preferably said loopbacks to establish an individual bidirectional channel between each said node network and allow recipients to obtain the communication channel of their choice;
(b)processing means including non-blocking matrix switching or routing means, buffering, packeting, and addressing means; processing said channels containing said services into digitised packaged data format and said addressing means identifying, storing and updating in real time the location of each recipient, whether fixed, vehicular or portable, and applying routing information to each packet of said digitised packaged data to enable said packets to be correctly routed through the system to reach each recipient.

The system also can include multiplexing means wherein said packets for multiple recipients are combined together to enable said packets to be conveyed to recipients using a single connection means, said packets remaining identifiably separate from each other and being routed to each said recipient according to the routing information contained in or applying to each said packet.

The system can include a plurality of gateways and the system allows connection between said gateways to share the load and introduce redundancy. One or more gateways include repository means for storing system software required by downstream devices, and enabling downloading of said system software to said devices to remotely refresh or upgrade said downstream devices.

Splitting means can be connected with at least one of said connection means and able to split said Internet media streams or data or packets derived therefrom into as many duplicates as necessary to satisfy the number of recipients for each said stream.

Channel optimisation means are used for gathering and processing real-time or near real-time ionospheric propagation data, automatically determining suitable channels for high frequency radio links used by this system, and managing said channels to maximise the quality of service and efficiency of spectrum utilisation by controlling transmitter frequencies, powers and other parameters used by the equipment providing said high frequency links.

The gateways can include monitoring means for collating the time of day and day of the week when particular Internet media streams are requested, and using fuzzy logic as a means of prediction, for the selection means to open an individual bidirectional channel with one of said external communications node or network from which said stream is obtainable in advance of the predicted likely time of request to make operationally negligible the time required to establish said stream with said external source.

The connection means for connecting recipients to processing means includes any combination of a plurality of optical fibre, hybrid-fibre coax, coaxial or other cable, satellite relay links, wideband radio links, and narrowband radio links, and further that said connection means for connecting recipients includes all necessary routing, multiplexing and demultiplexing, signal regeneration, radio transmission and reception, automatic link establishment, and means of duplex or quasi-duplex operation on said radio links and further that said connection means also allows digitised packaged data to be conveyed from each recipient to the gateway as required.

The connection means for connection to vehicular and portable recipients also includes short-range radio modems, said modems placed at regular intervals around the localities where wireless connections to vehicular and portable recipients are to be provided, said modems including means of a multi-access technique to enable each said modem to establish individual wireless connections with multiple vehicular and portable recipients.

Alternatively the connection means for connection to vehicular and portable recipients is provided by transponders, said transponders providing a means of decoding Internet media streams, modulating same onto individual radio-frequency carriers of appropriate frequency, and transmitting said modulated carriers to one or more recipients within range of said transponder, said transponders including means of sending information containing the frequency of requested streams to a radio modem near the requestor of that stream, said modem passing said frequency information to the requestor's equipment causing automatic tuning to the stream and receipt on said radio frequency.

The system can include various types of vehicle units, portable equipment and handsets as disclosed herein and hereinafter collectively called portable modems, said portable modems providing the means of wirelessly connecting vehicular and portable recipients, said portable modems including:
(a) means for inputting downloading storing and editing URLs for said broadcast and communications services;
(b) input means which in response to an action performed by the recipient, recalls from memory the URL of a desired Internet media stream and sends the URL to the gateway to cause said stream to be obtained by the gateway and delivered to said recipient via the connection means;
(c) converting means able to convert packets received from said gateway to an analogue or digital baseband signal, and performing all necessary processing and amplification to enable same to drive an internal or external audio or video transducer or other external equipment.

The invention also provides portable modems for use by vehicular and portable recipients which enable wireless connection to fixed short-range radio modems for delivering broadcast and communications services including provision of one or more Internet media streams, Internet audio streams and Internet video streams, Internet data, the world-wide-web and email, and telecommunications and for connection to one or more gateways which provide connections to external communications networks and nodes and internal loopbacks from which said services are obtained, said portable modems including:
(a) means for inputting downloading storing and editing URLs for said broadcast and communications services;
(b) input means which in response to an action performed by the recipient, recalls from memory the URL of a desired Internet media stream and sends the URL to the gateway to cause said stream to be obtained by the gateway and delivered to said recipient via the short range radio modem;
(c) converting means able to convert packets received from said radio modem to an analogue or digital baseband signal, and performing all necessary processing and amplification to enable same to drive an internal or external audio or video transducer or other external equipment.

The portable modem can include receiving means for receiving signals on free-to-air radio or television frequencies, demodulating said signals to an analogue or digital baseband signal, and performing all necessary processing and amplification to enable same to drive an internal or external audio or video transducer or other external equipment.

In one form modulation means are used to modulate an analogue or digital baseband signal obtained from an Internet media stream or a free-to-air station onto a radio-frequency carrier of appropriate frequency for reception by an external receiver tuned to the same frequency.

In another form the portable modem includes a means of making and receiving telephone calls through the connection means.

The portable modem can include a means of establishing a Bluetooth short-range wireless link with a handset enabling the user to make and receive telephone calls using said handset. The means of establishing a Bluetooth short-range wireless link with said handset enables the user to select a desired Internet media stream or station and function as a portable listening device for said Internet media stream or station.

The portable modem can include a means of providing access to the Internet including the world-wide-web and email through said modem. In another form a connection to an external computer enables a user of said computer to access the Internet including the world-wide-web and email through said modem. Alternatively a means of connection to an external computer with appropriate software enables said computer to function as an additional user interface for said modem.

The portable modem can include a means of monitoring the power drain of external equipment such as a conventional radio receiver, such that if said external equipment is switched on or off, said modem will automatically switch on or off in unison.

Also in accordance with the invention the system includes portable modems having a means of very-high frequency or ultra-high frequency radio transmission and reception including antenna means, to enable the means of connection to be completed using a point-to-point radio link if no other path is available, and operating duplex or quasi-duplex and employing means of automatic link establishment.

Also in accordance with the invention the system includes portable modems having a means of high frequency radio transmission and reception including antenna and antenna tuning means, to enable the means of connection to be completed using a high frequency point-to-point radio link if no other path is available, and operating duplex or quasi-duplex and employing means of automatic link establishment.

The system as defined hereinabove can include a relay means for relaying a group of bidirectional channels from one or more nearby short-range radio modems to multiple recipients located inside a shared space such as commuter vehicle, wherein:
(a) recipients are using handsets;
(b) the connections to said handsets are made using a shared multi-access technique such as Bluetooth;
(c) to the extent allowed by the handsets, recipients are able to independently access the service of their choice, including the ability to make and receive telephone calls, the ability to select and listen to Internet media streams, and the ability to connect a portable computer to their handset and access the Internet including the world-wide-web and email through said handset.

The system as defined hereinabove can include an additional relay means for relaying a group of bidirectional channels from a satellite transponder to recipients located on board an aircraft.

The invention also provides a system wherein the connection means for connecting recipients at fixed locations includes modems which receive packets from the connection means and converts said packets into a form which is recognised by a set-top-box, said set-top-box functioning as a hub for the recipient's external media, computing and telecommunications equipment, wherein it provides a means of converting Internet media streams to analogue or digital baseband signals as appropriate, and also performing all necessary processing and amplification to enable same to either drive the recipient's external media equipment through wires, or else to be modulated onto a radio-frequency carrier of suitable frequency and transmitted wirelessly for reception by said equipment on the same frequency.

Still in another form the invention provides a set-top-box for connection to recipients at fixed locations by modems delivering broadcast and communications services including one or more Internet media streams, Internet audio streams, Internet video streams, Internet data, the world-wide-web and email, and telecommunications; and connecting to one or more gateways which provide connections to external communications networks and nodes and internal loopbacks from which said services are obtained, said set-top-box including receiving means of receiving packets of said services processed into digitised packaged data format from a connection means and converting said packets into a useable form for said set-top-box to function as a hub for the recipient's external media, computing and telecommunications equipment, wherein the set-top-box provides a means of converting Internet media streams to analogue or digital baseband signals as appropriate, and also performing all necessary processing and amplification to enable same to either drive the recipient's external media equipment through wires, or else to be modulated onto a radio-frequency carrier of suitable frequency and transmitted wirelessly for reception by said equipment on the same frequency.

The set-top-box include receiver means for receiving signals on free-to-air radio or television frequencies, demodulating them to analogue or digital baseband signals as appropriate, and performing all necessary processing and amplification to enable driving of the recipient's external media equipment through wires, or to be modulated onto a radio-frequency carrier of suitable frequency and transmitting wirelessly for reception by said equipment on the same frequency. The set-top-box can include means of connection to an external computer to enable it to access the Internet including the world-wide-web and email through said set-top-box. Further the set-top-box includes a means of physical connection to an external telephone to enable it to make and receive telephone calls through said set-top-box.

The set-top-box can include a means of establishing a Bluetooth wireless link with a portable handset to enable the user to make and receive telephone calls through said set-top-box. The means of establishing a Bluetooth wireless link with one or more remote control units can enable the user to control the selection of Internet media streams and free-to-air stations delivered to the recipient's external media equipment. There can be included a means of requesting information from one of the gateways and downloading received information to the recipient's remote control units, to enable control of the recipient's external media equipment through the infrared links of said equipment.

Receiver means can be included enabling services to be obtained from a satellite relay link, and to direct said services to a means of radio transmission and reception, said means of transmission and reception providing the means to forward said services to an outlying recipient using a high-frequency, very-high frequency or ultra-high frequency radio link.

Remote control units are able to transmit commands using both Bluetooth and infrared, to enable said units to control the recipient's external media equipment separately from the set-top-box. The remote control units can have a means of being associated with more than one type of external media equipment, and being able to be quickly and easily switched between infrared command sets applicable to each type of said equipment. The remote control units could include a means of storing combinations of commands that are retrieved and transmitted as a group.

The system of the invention can have one or more of external media equipment including a means for the recipient to store information and notes on program or content, and to send an order to a supplier via the connection means to purchase items heard or viewed using any media device disclosed herein.

One or more means of receiving services can be from a modem or satellite relay link, said means being spatially arranged in a grid or other suitable pattern across the area to be covered, said means being able to relay services to multiple recipients using any suitable frequency including high-frequency, very-high frequency and ultra-high frequency radio links, said radio links operating duplex or quasi-duplex and employing means of automatic link establishment.

In variations of the system there is included equipment able to respond to remote commands to change frequency band, scan channels, test channel quality, adjust transmitter power, and report to the optimisation means for the purpose of optimising channel quality and efficiency of spectrum utilisation.

The system could includes a means of connecting two set-top-boxes using a broadband radio link, such that said set-top-boxes operate as if sharing a common bus.

The invention also provides a system that includes a means of automatic link establishment wherein:
(a) links are established for any reason including a request for service or a request to pass traffic;
(b) the device which initiates link establishment is herein called the requester;
(c) in the absence of a link, each device continuously monitors its allocated ultra-high frequency wireless channel;
(d) in the absence of a link, each device scans the high-frequency paging channels, said channels reserved for signalling and spaced across the allocated high frequency range;
(e) in the absence of traffic, each device simultaneously monitors the high-frequency and ultra-high frequency channels;
(f) when service is required, the requestor initially transmits a request for service on the allocated ultra-high frequency channel;
(g) if the requestor does not receive an acknowledgment from the other device within a reasonable time period, it repeats the request a designated number of times;
(h) if the requestor has sent a request for service on the allocated ultra-high frequency channel the designated number of times without receiving an acknowledgement, it changes to a high-frequency paging channel chosen according to an algorithm which attempts to determine the channel with the highest probability of success, based on parameters including one or more of the frequency and time of the most recent high frequency communication, the current time, the current date, blocked channel list, and any other relevant information;
(i) if the requester fails to receive an acknowledgement on this channel within the designated period of time, it switches to the next paging channel and repeats the process until it receives an acknowledgement from the other device;
(j) when the requestor receives an acknowledgement, it performs a handshaking sequence with the other device;
(k) after handshaking and at any time thereafter, the devices test other channels which have been notified as available, to find the best one and change to it;
(l) during the process of link establishment, the requestor and provider check that each is authorised to communicate with the other;
(m) during the process of link establishment, the uplink device contacts the gateway to obtain a list of channels which can and cannot be used, and any other data or parameters such as maximum authorised power on each channel;
(n) during the process of link establishment, the devices adjust their transmitter power to the minimum needed for reliable communication;
(o) if the link has been established in response to a need to send traffic in the uplink direction, said traffic is then forwarded;
(p) if the link has been established in response to a need to send traffic in the downlink direction, the downlink device notifies the uplink device that it is ready to receive said traffic, which is then forwarded;
(q) if a high-frequency wireless link has been established and either device determines that no traffic has been passed for a designated time period, said device pings the other device and waits for a response to determine whether the link is still open and available;
(r) if the device fails to receive a response after sending a designated number of pings, it reverts to the idle state;
(s) if the device which reverts to the idle state is at the uplink end of the link, it notifies the gateway that the channel is no longer in use to enable it to be allocated to other users of the system;
(t) to minimise the probability of contention between users of the system, pings are allocated specific time slots which, to the extent possible, are unique for each device;
(u) the technique is substantially as herein defined.

The system can deliver Internet media streams, Internet data, telecommunications and third party services to fixed, vehicular and portable recipients.

This invention can be seen to disclose a method of delivering Internet media streams, Internet data and telecommunications to fixed, vehicular and portable recipients in any location, said media streams including Internet audio, Internet video, Internet radio and Internet television, and said Internet data including the world-wide-web, email, news, Internet relay chat, and similar services. The invention can also deliver high quality video streams for displaying on television screens of conventional size.

### BRIEF DESCRIPTION OF THE DRAWINGS

In order that the invention is more readily understood an embodiment will be described by way of illustration with reference to the drawings with the features specified in Appendix A wherein:

FIG. 1 is a diagrammatic view of the overall system for delivering broadcast and communications services in accordance with an embodiment of the invention;

FIG. 2 is a block diagram of a gateway of the overall system for delivering broadcast and communications services of FIG. 1;

FIG. 3 is a broad view of the connection means of the overall system for delivering broadcast and communications services of FIG. 1;

FIG. 4 is a detailed block diagram of part of the connection means of the overall system for delivering broadcast and communications services of FIG. 1;

FIG. 5 is a diagrammatic view of a catenary mounted short-range radio modem for use in one form of the overall system for delivering broadcast and communications services of FIG. 1;

FIG. 6 is a diagrammatic view of a pole mounted short-range radio modem for use in one form of the overall system for delivering broadcast and communications services of FIG. 1;

FIG. 7 is a block diagram of connection to radio transponders in the overall system for delivering broadcast and communications services of FIG. 1;

FIG. 8 is a front diagrammatic view of a vehicle unit for use in the overall system for delivering broadcast and communications services of FIG. 1;

FIG. 9 is a diagrammatic view of vehicle unit connections for the vehicle unit of FIG. 8;

FIG. 10 is a block diagram of the vehicle unit of FIG. 8;

FIG. 11 is a diagrammatic front view of a handset for use in the overall system for delivering broadcast and communications services of FIG. 1;

FIG. 12 is a functional block diagram of the handset of FIG. 11;

FIG. 13 is a diagrammatic front view of a set-top-box for use in the overall system for delivering broadcast and communications services of FIG. 1;

FIG. 14 is a functional diagrammatic view of connections to the set-top-box of FIG. 13;

FIG. 15 is a functional block diagram of the set-top-box of FIG. 13;

FIG. 16 is a diagrammatic view of a group repeater for use in the overall system for delivering broadcast and communications services of FIG. 1;

FIG. 17 is a functional block diagram of the group repeater of FIG. 16;

FIG. 18 is a diagrammatic block diagram of remote links showing private and public access in the overall system for delivering broadcast and communications services of FIG. 1;

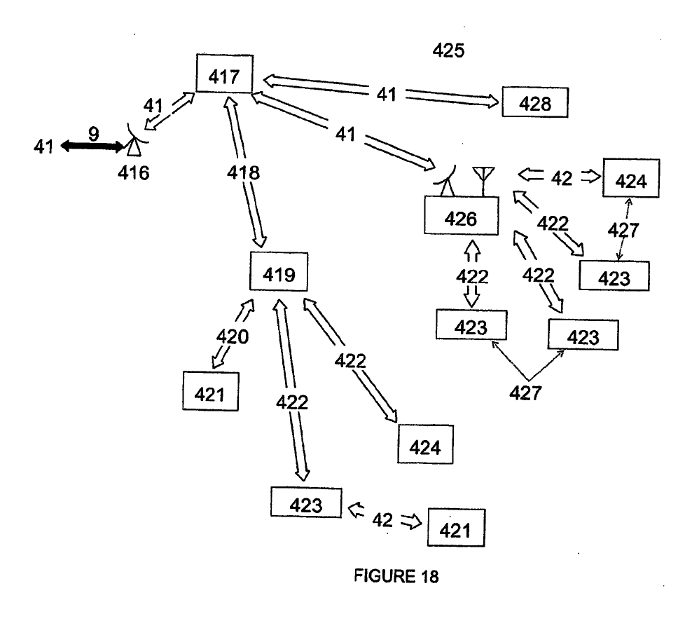

FIG. 19 is a functional block diagram of the connections of a long range set top box in the overall system for delivering broadcast and communications services of FIG. 1;

FIG. 20 is a functional block diagram of a long range transceiver in use the connection of long range set top box of FIG. 19;

FIG. 21 is a diagrammatic view of a long range vehicle unit for use in the overall system for delivering broadcast and communications services of FIG. 1;

FIG. 22 is a functional block diagram of as long range adaptor for use in the overall system for delivering broadcast and communications services of FIG. 1;

FIG. 23 is a diagrammatic perspective view of an antenna tuning unit for use in the overall system for delivering broadcast and communications services of FIG. 1;

FIG. 24 is a functional block diagram of the antenna tuning unit of FIG. 23;

FIG. 25 is a diagrammatic block diagram of a relay site with co-located high frequency transmitters and receivers for use in the overall system for delivering broadcast and communications services of FIG. 1;

FIG. 26 is a diagrammatic block diagram of a relay site with separate high frequency transmitters and receivers for use in the overall system for delivering broadcast and communications services of FIG. 1;

FIG. 27 is a diagrammatic view of an aircraft installation of connection for use in the overall system for delivering broadcast and communications services of FIG. 1;

The diagrams and descriptions herein are functional, and disclose general principles of operation.

### DESCRIPTION OF PREFERRED EMBODIMENT

System

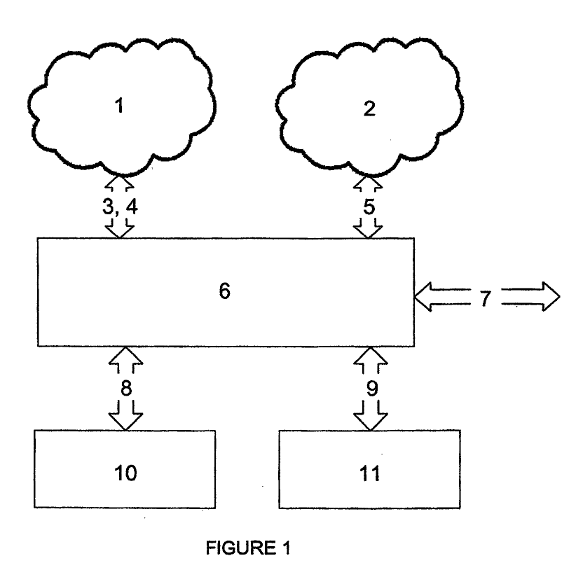

As shown in FIG. 1, access to the nodes for the Internet (1) and external telecommunications networks (2) are concentrated into one or more gateways (6). Internet services include Internet media streams (3) and Internet data of all types (4). Telecommunications (5) includes telephony, facsimile, short message service (SMS), and generalized packet radio service (GPRS). The gateways serve local service areas (10) using local links (8), and remote areas (11) using remote area links (9). Gateways may be linked using broadband trunks (7) to share resources and provide redundancy in the event of external link or node failure.

Gateway

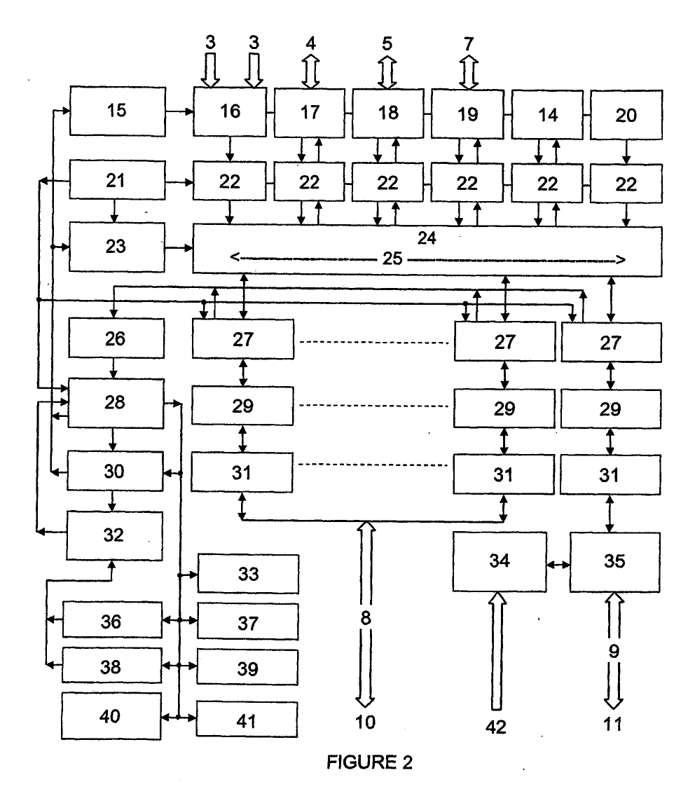

As shown in FIG. 2, the gateways include multiple servers (16) and (17) to access Internet media streams and Internet data respectively. Gateways include internal loopback means (14) to enable traffic to originate and be received within the system, without having to exit the system. Gateways may include additional interfacing (18) and (19) to access external telecommunications networks and other gateways. Gateways may also include a system software server (20), the function of which is to store operating software for devices included in the system, to be downloaded to them when necessary.

The uniform resource locators (URLs) for the Internet media servers (16) are provided by a URL predictor, register and generator (15). This attempts to anticipate when particular media streams are likely to be requested, based on previous user requests, and issue the corresponding URLs to a spare Internet media server before the expected time of request. Its purpose is to ensure that streams are present before users select them, to maximize system responsiveness. The URL predictor, register and generator includes a means of identifying the type of service available from that URL, to ensure that only URLs associated with streaming are stored and predicted.

Each incoming Internet media stream, Internet data transaction, telecommunications service, or system software module is buffered and re-clocked by buffering and re-clocking devices (22), according to timing information supplied by the master clock generator (21). The buffered and re-clocked stream or data is then routed to virtual user ports (25) by a non-blocking matrix switch or routing means (24), according to information supplied by an address generator (23). Each virtual user port contains high-speed serial data, which is multiplexed for all users currently accessing that port. The streams and data for each user is packeted by packeting and de-packeting devices (27), to add extra bits containing the destination address or routing information, type of data, checksum, and any other necessary information. To ensure correct routing through the non-blocking matrix switch or routing means and packeting and de-packeting devices, the processing modules mentioned in this paragraph are required to remain perfectly synchronized at all times.

The packets from the packeting and de-packeting devices (27) are then forwarded to a bank of demultiplexers (29) and encryption devices (31). The purpose of the demultiplexers is to divert packets to the particular local or remote link, which corresponds to the routing information and destination address in the packet, and the purpose of the encryption devices is to ensure privacy for users and also to prevent unauthorized use of the system.

Packets entering the gateway from a local or remote link are decrypted by (31), multiplexed by (29), and de-packeted by (27). The type of data in each packet is examined by the service identifier (26) from the packeting information. If the packets contain user-generated traffic such as Internet media streams, Internet data or telecommunications, they are multiplexed by (29) and fed to the virtual user ports on the non-blocking matrix switch or routing means. The non-blocking matrix switch or routing means reduces this traffic to individual streams, data or telecommunications channels as applicable, and feeds it to the appropriate buffering and re-clocking device (22) according to the address supplied by the address generator. The buffer and re-clocking device then feeds this traffic to the corresponding server or other external interface (16) (17) (18) or (19).

If the packets contain user-generated requests for a different stream or type of service, or if they contain system-generated data, they are instead routed to the service identifier, which identifies the nature of the data and passes it to the main processor (28). The main processor passes new URLs to the URL predictor, raw routing information to the address generator, and processes other information according to its type.

The system supervisor (30) continuously compares the routing information for outgoing packets with the known location of each user, as reported by downstream devices. If downstream devices report a changed user location, the system supervisor updates the routing information for that user to ensure that outgoing packets are always correctly addressed. The functions of home and visitor location registers are provided by (36) and (38) respectively.

The system is monitored and controlled through an engineering interface (33). System diagnostics are provided by (37). A customer website and dial-in service are provided by (39) and (41) respectively, and subscriber records and billing by (40). Other administrative functions or information paths may also be required.

To connect users in remote areas, who cannot be connected by other means such as optical fiber or terrestrial microwave radio, a multi-channel satellite transceiver (35) passes data via one or more satellite transponders (417). These comprise the first part of each remote link. Further downstream, the remote links may also employ ultra-high frequency (UHF) and high frequency (HF) radio links.

Frequency Management Sub-System

To ensure the efficient allocation of HF frequencies used by remote area links, a frequency management sub-system (FMS) (34) continuously seeks to optimize HF channel allocation in terms of quality and availability for re-use. To achieve this, data from ionospheric sounders installed at various locations around the remote area may be processed to provide real-time prediction parameters for those locations. If the gateway receives a request for service on an HF channel, it first instructs the FMS to select the prediction parameters applicable to the user's location, and then calculates the optimum frequency. The FMS then compiles a list of channels around this frequency, where the chance of interference to or from other users is minimal, and downloads the list to the user. The user's equipment scans these channels, selects the best one, sets the transmitter to the minimum power needed for good communication, and notifies the channel and power to the FMS. To prepare for requests from other users, the FMS then calculates the minimum re-use distance for this channel, and stores the result in its database of current HF links. At the end of a radio or telephone session or after a certain period of inactivity in Internet data mode, the user's equipment notifies the FMS that the channel is free for reallocation. In addition, the FMS may periodically interrogate users to see if their channels are still in use, and if it finds one which has been relinquished, may set it aside for reallocation.

To allow for variations in propagation with time of day, the FMS may periodically reassess all HF frequencies in current use. If changes are found to be required, the FMS will forward frequency change commands to those users affected. Likewise if a recipient experiences poor conditions or interference on a particular channel, he or she can manually queue a request a new one from the FMS.

HF is used by several devices disclosed herein, including the long-range vehicle unit (423), long-range handset (424), long-range transceiver (449), and similar devices used by a facility herein disclosed and called a relay site (426). These devices include a means of recognizing commands sent from the FMS, which preferably includes a means of in-band data signaling, and a handshaking routine to provide a means of confirmation.

Local Links

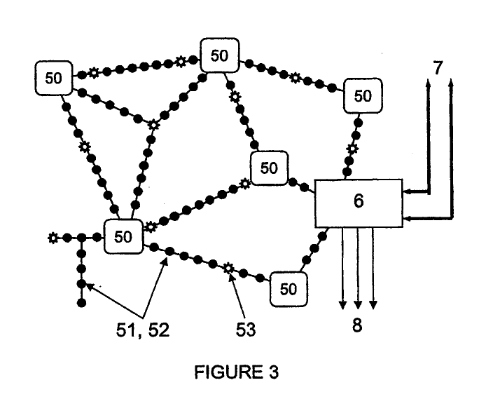

As shown in FIG. 3, local links may employ optical fiber, hybrid-fiber-coax (HFC), or other high data rate communications technology to connect users in local service areas to gateways. To enable these links to be shared with other services, for example existing pay TV services, local links may employ time and/or wavelength division multiplexing to avoid interference between services.

Local links include routers (50), radio modems (51) and set-top-box modems (52) in a daisy chain formation. They may also include devices herein disclosed and called media transponders (53). The links are preferably meshed to provide redundancy and improve system reliability.

The function of the routers is to demultiplex the data coming from the gateway, and direct it to the modem or media transponder that is closest to each user. Each router feeds a certain number of adjacent modems. The routers also multiplex data coming back from users and forward it upstream to the gateway. Most such data comprises telecommunications, requests for different Internet media streams, and Internet data generated by users (mainly web browsing and email). Other data emanating from the routers and modems, which is fed upstream, may include status reports, user location, key exchange, etc.

The function of the radio modems is to connect vehicular and portable users, the function of the set-top-box modems is to connect fixed users, and the function of the media transponder is to connect additional vehicular and portable users for Internet media streams only.

Radio Modem

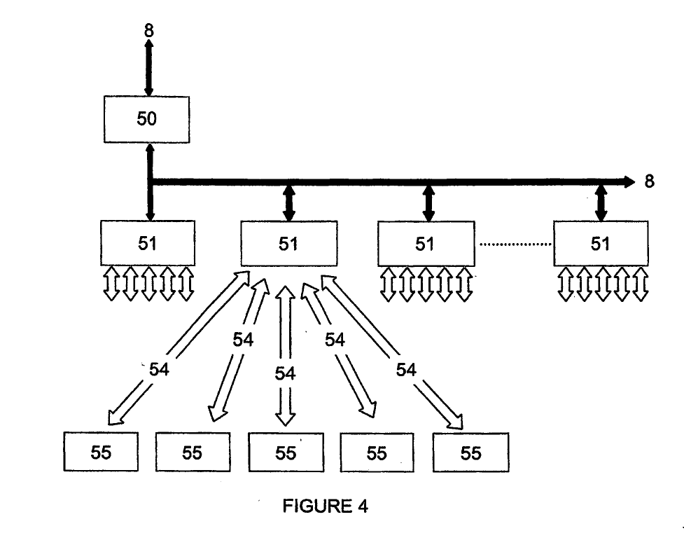

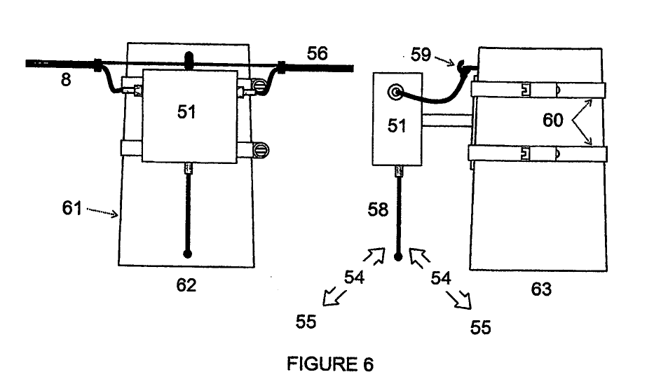

As shown in FIGS. 4, 5 and 6, the radio modems may be mounted on catenary wires (56), utility poles (61), and other convenient locations along roads, in railway tunnels, industrial estates, shopping centers, recreational venues, public buildings, and any other place requiring coverage by the system disclosed herein. Their spacing and radio frequency output power is preferably adjustable so that during peak usage, they are utilized as fully as possible, while maintaining sufficient margin to accommodate peak usage. In most metropolitan locations, the spacing of radio modems may be typically tens to hundreds of meters. The transmitter output power of each radio modem is preferably adjustable from the gateway.

Data arrives at the modems in the form of packets, and enters through a coaxial or optical baseband interface (57). Circuitry in the modems examines the address of each packet, and if any are found which correspond to the address of a user being serviced or likely to be serviced by that modem, the packet is extracted, buffered and re-clocked to reduce the data rate.

In the preferred implementation, the data for each user is modified by a unique spreading code and modulated onto a radio frequency carrier wave using code division multiple access (CDMA). To ensure orthogonality, the codes may be obtained from pools shared by modems in the same general vicinity. The modulated carrier wave is then amplified and transmitted using an omnidirectional antenna (58) over a short-range wireless link (54) to vehicular and portable devices (55) within range of the modem. These devices are disclosed herein, and include various types of handsets, and various types of vehicle unit.

In the reverse direction, radio signals received from users are separated out, fed to a CDMA receiver, and de-spread using the code corresponding to each user. The data signal from each user is then shaped, buffered, multiplexed, and passed upstream to the router associated with that particular radio modem.

It is preferred that each radio modem services between approximately 25 and 50 people. These numbers are subject to revision. It is also preferred that the modems be located to provide blanket radio coverage of all potential listening locations throughout the service area, except inside and around fixed residences and buildings, where hardwired or set-top-box modems may be used instead of radio modems.

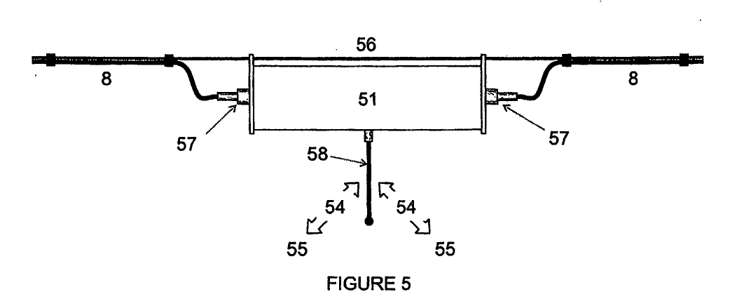

Due to the short communications distances, radio modems are preferably not mounted very high, except where necessary to connect elevated users. FIGS. 5 & 6 show catenary and pole mounting respectively.

Radio modems require a frequency allocation that allows the use of short antennas, has limited range, and does not interfere with other services. Frequencies displaying these characteristics include the region around 2 GHz and above. To avoid mutual interference, nearby radio modems should operate on different center frequencies, following similar techniques for frequency re-use which are employed in cellular telephone networks.

Data may be transferred at various rates, for example approximately 9.2 kb/s per user for telecommunications and Internet data uploads, 128 kb/s per user for Internet audio streams and Internet data downloads, and 2.048 Mb/s per user for high quality compressed Internet video. These data rates are subject to revision, and other data rates may be used without altering the principle of the invention.

For portable and vehicular users, it is preferred that all services except Internet video are handled by radio modems as disclosed herein, and that Internet video be handled by media transponders as disclosed herein. For fixed users, it is preferred that all services be handled by set-top-box modems.

If more than one user of a particular radio modem is receiving an Internet media stream, the same access code may be provided to each of these users, allowing them to access the same stream. Also, to ensure graceful degradation if the number of recipients exceeds the number of full-rate channels available from a radio modem, said radio modem may automatically reduce the per user data rate to maintain the connections to each of its recipients.

Media Transponders

Radio Transponder

Many locations experience a highly diurnal or seasonal population, for example beaches, recreational areas, tourist towns and holiday resorts. If these were to be served only by standard radio modems, a large number of modems could be required to accommodate the peak usage, but which are greatly under-utilized the rest of the time. This would be inefficient and expensive.

To overcome this problem, it is preferred that radio modems be able to hand off excess Internet audio streams, which would exceed the available modem capacity, to low power FM transmitters covering the same general location. These transmitters are herein called radio transponders. Their range may significantly exceed that of a standard radio modem, possibly up to a km or more, depending on the situation. Therefore to allow the range to be tailored, it is preferred that the transponder power be remotely adjustable from the gateway. The power per channel may be tens to hundreds of mW- (indicative). Although FM is mentioned here, medium frequency AM could also be used, subject to its greater susceptibility to interference and the need for a larger transmitter antenna. Note that transponders have no ability to receive radio signals from users.

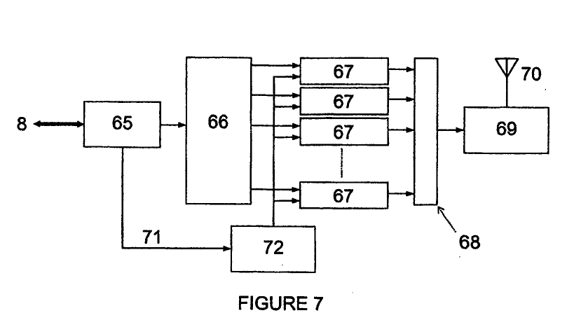

As shown in FIG. 7, it is preferred that radio transponders be connected to local links (8), from which they receive, decode and retransmit Internet audio streams for that particular location. If a user in that location requests or changes an Internet audio stream, his or her vehicle unit or handset sends a request to the nearest radio modem, which forwards it to the gateway. The gateway may respond by sending the requested stream to the modem. Upon receiving the stream, the radio modem may check to see if it has sufficient capacity to transmit it. If it possesses sufficient capacity, it transmits the stream to the vehicle unit or handset making the request. If not, it sends details of the requested stream to the radio transponder serving that area. Upon receiving these details, the transponder checks to see if it is already transmitting the stream, and if so, notifies its transmission frequency to the radio modem. If the transponder is not already transmitting the stream, the transponder decodes it from the local link (because it already exists on the local link), allocates a frequency, and commences transmitting said stream. The transponder also notifies the requesting radio modem of the frequency allocated to said stream. In turn, the modem forwards details of said frequency to the vehicle unit or handset, which activates its internal radio receiver and tunes to the frequency where the stream is being transmitted by said transponder. Alternatively, the radio modem and transponder may exchange data and commands via the gateway instead of directly with each other.

Since the streams convey only Internet audio, and the transmitted signals cannot be associated with any particular user, there is no need for encryption. This avoids a source of significant audio distortion, and allows each transmitted stream to have more than one user. It also simplifies the receive path of the user's vehicle unit or handset, thereby helping to minimize size and weight. Although the absence of encryption allows reception by an ordinary receiver, an eavesdropper has no control over the program he or she might hear on any particular frequency, and in the absence of a station announcement, will not even know what it is. Since streams and frequencies will often change without warning, eavesdropping will be a frustrating experience, which few people are expected to pursue for any length of time. These FM links are also usually short range, and in most cases inaudible beyond a few km.

In an alternative implementation, the transponder does not decode Internet audio streams, but may transmit them over the FM channel using a bandwidth-efficient form of digital modulation that is decoded in the handset or vehicle unit.

To minimize interference between areas served by adjacent transponders, and also minimize the need to change frequency if a vehicle unit or handset moves from one area to another, the streams common to these transponders are preferably allocated the same frequency where practical. This requires streams and frequencies to be centrally coordinated, and rearranged from time to time to optimize allocation.

TV Transponder

TV transponders provide the means of receiving Internet video streams in vehicles. They operate similarly to radio transponders, except that they convert Internet video streams to individual radio frequency signals with frequencies, bandwidth and modulation corresponding to those used for normal UHF TV transmission. Also, if a vehicular user requests an Internet video stream, the gateway determines the TV transponder which is closest to the user, commands the transponder to commence transmitting a radio frequency signal at a particular frequency, forwards the stream to the transponder for modulating onto this signal, and commands the vehicle unit which issued the request to activate its free-to-air TV receiver and tune to the nominated frequency. This transponder may include a means of scrambling to accommodate subscription broadcasting if required.

TV transponders are likely to have relatively few users, allowing their range to exceed that of the average radio transponder. This, together with the wider channel bandwidth, means they are likely to transmit at a higher power than the average radio transponder.

Vehicle Unit

General Description

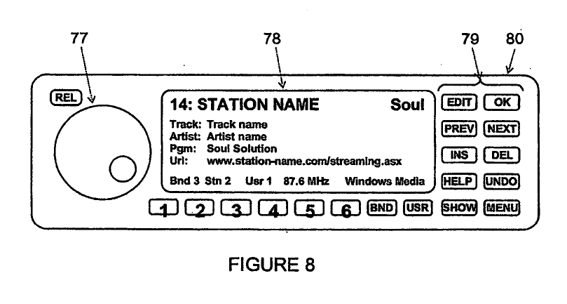

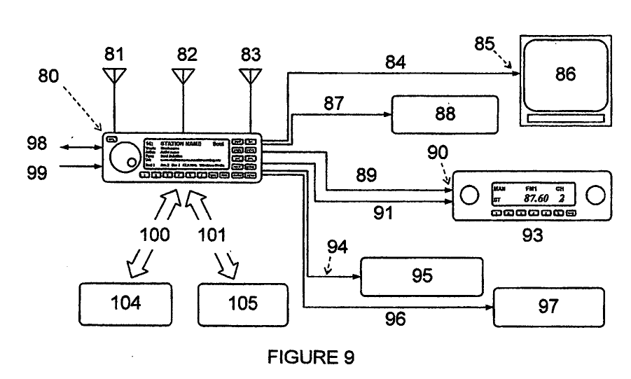

As shown in FIGS. 8 and 9, radio modem signals are received in vehicles by vehicle units, preferably mounted within easy reach of the driver. Vehicle units function as a hub, and may include the ability to:
(a) search for a radio modem, establish a wireless connection thereto, and exchange packets containing services described herein with said modem;
(b) if the service comprises an Internet audio stream, decode said stream to audio;
(c) activate an internal free-to-air radio receiver or TV receiver, tune to AM, FM and TV signals as applicable, and demodulate them to audio or audio/visual (A/V) baseband as applicable;
(d) perform any additional processing and amplification needed to drive an external speaker system, an external audio device, or a low power FM modulator for feeding to the antenna input of an external AM/FM radio receiver of conventional design;
(e) perform any additional processing and amplification needed to drive an internal video display and speaker, an external video device, or a low power TV modulator for feeding to the antenna input of an external TV receiver;
(f) connect to a computer (104) via a cable, Bluetooth wireless link or infrared link (100), said computer being able to send and receive Internet data using this system, and preferably perform other functions such as setting up the vehicle unit and functioning as an alternative front panel for said vehicle unit;
(g) connect to a handset (105) via a Bluetooth wireless link (101), said handset being able to initiate and receive telephone calls, send and receive SMS messages, and provide other telecommunications services;
(h) connect to a handset via a Bluetooth wireless link, said handset being able to select Internet audio streams and free-to-air radio stations and play them through an acoustic transducer associated with said handset;
(i) be controlled by a remote control unit.

Vehicle units may include a station selection knob (77), display (78), keypad or buttons (79), and computer port.

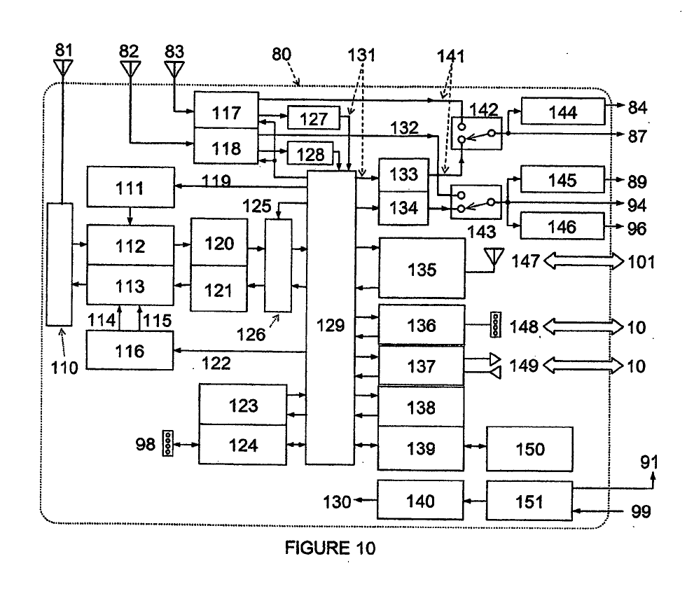

FIG. 9 shows the vehicle unit connections, and FIG. 10 shows a functional block diagram. These diagrams show various output possibilities including a low-level baseband signal, a low level modulated radio frequency signal, and a high level audio signal.

As shown in FIG. 10, signals from a radio modem are received on antenna (81), routed through a transmit-receive diplexer (110), and downconverted and processed by a receiver (112). The bandwidth control (111) selects wide receiver bandwidth or high data rate for Internet audio streams and Internet data downloads, and narrow receiver bandwidth or reduced data rate for telecommunications. The receiver output signal is digitized by a baseband receive modem (120) and decrypted by (126). Although this provides medium grade security, sufficient to protect user privacy and prevent unauthorized use of the system, it is not intended to replace the encryption built into the handset.

After passing through a programmable logic device (PLD) or other processor (129), which switches the signal paths and provides other functions including glue logic, the stream is decoded by audio codec (134) and switched by (143).

The vehicle unit may also include an internal AM/FM receiver (118) that is suitable for receiving signals on free-to-air radio frequencies. The audio output of this receiver is switched by (143), and provision for receiving digitally modulated signals is provided by the analog to digital converter (ADC) (128) and codec (134). The selected audio signal may be fed to a low power FM modulator (145) for reception by an external FM receiver of conventional design (93), or to a low-level audio output (94) for unspecified external equipment (95), or to an audio amplifier (146) to drive external speakers (97).

The vehicle unit may also include a TV receiver (117) that is suitable for receiving signals on free-to-air TV channels. The baseband output of this receiver is switched by (142), and provision for receiving digitally modulated TV signals is provided by ADC (127) and codec (133). The selected A/V signal may be fed to a low power TV modulator (144) for reception by an external TV receiver of conventional design (86), or to a low-level A/V output for unspecified external equipment (88), or to a small internal video display.

In the reverse direction, transmitted signals are encrypted by (126), converted to a form suitable for modulation by the baseband transmit modem (121), modulated and amplified by a transmitter (113), and routed through the diplexer (110) to the modem antenna (81).

The frequency generator (116) controls the receive and transmit frequencies, and the CDMA spreading code (122) is preferably orthogonal to other users of the same radio modem.

The Bluetooth wireless link (101) provides a short-range wireless connection to an external laptop or handheld computer (104) and a handset (105). To avoid signal dropouts due to multipath within a vehicle, this link may include frequency diversity. A data connector (102) is included, to allow the use of computers that do not possess Bluetooth. An infrared interface (103) may be included for suitably equipped computers.

The baseband input/output expansion port (98) is reserved for use by the long-range adaptor (497), and preferably uses standard high-speed bus architecture such as USB, Firewire or Ethernet.

The PLD (129) identifies and processes user requests, gateway commands, incoming telephone calls, and incoming email. It also selects the receiver bandwidth according to the type of service, manages the key, applies the CDMA spreading code, switches signal paths, and manages data buffering such as the background downloading of emails.

Memory includes the receive and transmit buffers (123) to maintain a steady data flow, station memory (138), scratchpad memory, and non-volatile or flash memory for system use. The system is locally controlled by the system controller (139) and the user interface comprising keypad, display and beep (150).

The vehicle unit may also include a DC current sensing circuit (151) to measure the current taken from the DC power source (99) by external equipment such as a conventional AM/FM radio receiver (93). If the user switches on said external equipment, its current drain is detected by the current sensing circuit, which in turn activates DC power switch (140) and switches the vehicle unit on. The purpose of this feature is to eliminate the need to separately switch the vehicle unit on and off, when used with the existing generation of vehicular AM/FM radio receivers.

Utilities may include a scheduler to alert the user or select specified stations at pre-programmed times, scratchpad memory to enable the user to store information like artist name, song title and other details, and a quick purchase utility.

Radio Mode

If the vehicle unit drives a speaker directly or is connected to an external amplifier and speaker, no external AM/FM radio receiver is needed. Otherwise the vehicle unit requires an external AM/FM radio receiver, said receiver being tuned to an unused frequency through which Internet audio streams and signals on free-to-air frequencies are conveyed at radio frequency (RF) by said vehicle unit.

Stations may be selected on the vehicle unit by turning the knob, pressing a station button, or other means described or claimed herein. Stations can be any mix of Internet and free-to-air. The display may also show radio data service (RDS) or similar piggybacked data when receiving a station that carries this service.

If the user selects an ordinary free-to-air radio station, the frequency of the internal receiver (118) is under his or her control. If the user selects an Internet audio stream that is handed off to a radio transponder, the receiver frequency is not under said user's control, but is controlled by commands originated by the transponder or other system device.

The ability to receive digitally modulated FM signals provides a growth capability for next generation FM broadcast stations which employ digital modulation, and also for digitally modulated signals transmitted by the radio transponders described herein, if said digital modulation is implemented at a future date.

Due to the limited size of the display and keypad, the vehicle unit software preferably includes a custom browser. The purpose of this browser is to interpret and display relevant information from a streaming website, and also to interpret user keystrokes or other user input to enable said user to interact meaningfully with said website.

It is preferred that an attached external computer be able to display complete web pages in parallel with the interpreted information shown on the vehicle unit's display, thereby allowing more complex interactions between the user and streaming websites if desired, as described for the Internet Data Mode disclosed herein.

TV Mode

To be able to view TV signals, functional blocks including (83) (117) (127) (133) (142) and (144) must be installed in the vehicle unit. Also, either an external vehicular TV receiver (86) must be connected, or the vehicle unit must be equipped with a viewing screen of appropriate size.

TV stations are selected on the vehicle unit by turning the knob, pressing a station button, or other selection means described herein. Stations can be any mix of Internet and free-to-air. The display may also show Teletext or other piggybacked data when receiving a station that carries this service.

If the user selects an ordinary free-to-air TV station, the frequency of the internal TV receiver (117) is under his or her control according to the selected channel. If the user selects an Internet video stream, the receiver frequency is not under the user's control, but is automatically tuned to the frequency of the stream transmitted by the assigned TV transponder, in response to commands received from the vehicle unit through a nearby radio modem.

Internet Data Mode

Normal web URLs can be stored in the vehicle unit as radio channels, even if said URLs do not provide streaming. To recall them, the user can turn the knob or press the assigned station select button on the vehicle unit, upon which the page corresponding to the requested URL will be presented to the computer.

It is preferred that the vehicle unit allows email and other low speed data to be transferred in the background, without interrupting radio or TV reception. Email may be identified by its TCP/IP port address.

It is preferred that by pressing a particular key sequence, the vehicle unit sends a specific command to the computer, which may be recognized by said computer causing it to perform a pre-defined action according to a program stored in it by the user. It is further preferred that said computer be able to enter or edit station settings on the vehicle unit, and change other parameters as required.

To minimize size and cost, a web-only version is also preferred in which only the circuit blocks required for Internet data are installed.

Telecommunications Mode

Incoming telephone calls are identified by the packet header, which is recognized by the vehicle unit causing an audible alert to be emitted by the handset. When the user answers the call on the handset, the vehicle unit halts any media streaming that is currently in progress, and changes to telecommunications mode to enable two-way telephony to commence. When the telephone call is terminated, the vehicle unit switches back to its previous activity, requests the previous stream or service from the gateway, and resumes whatever it was doing before the call arrived. Outgoing calls preferably cause the vehicle unit to change to telecommunications mode when the dialing code is sent. Signals received from a media transponder may not need to be interrupted by telecommunications traffic, because they follow a different circuit path through the vehicle unit to that used for telecommunications.

To enable receipt of messages from the Generalized Packet Radio Service (GPRS), the unit may increase the incoming data rate and RF bandwidth up to the limit of the modem wireless link.

To minimize disruption to other activities, it is preferred that short message service (SMS) text strings be handled as background tasks.

Handsets

Several handset versions are disclosed. The simplest version is herein disclosed and called a short-range handset, wherein all communication takes place using a Bluetooth wireless link. Therefore this handset can only be used in the vicinity of a compatible device belonging to this system, said devices including a vehicle unit, set-top-box and group repeater described herein. The main application of this handset version is therefore where minimum size, cost, and power consumption are important.

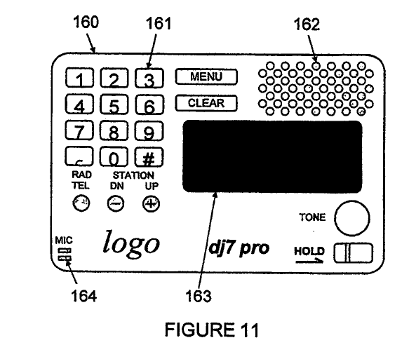

Another version is herein disclosed and called a standard handset. This version includes the capabilities of the short-range handset version described herein, to which is added the ability to wirelessly connect to a radio modem in a similar manner to a vehicle unit, in order to make it usable on the street. One implementation may be limited to telephony, and be similar in appearance to a conventional GSM handset. Another implementation (160) may include telephony, Internet media streaming, and free-to-air radio reception, and be similar in appearance to a portable AM/FM radio receiver of conventional design, as shown in FIG. 11. The inclusion of free-to-air radio reception also allows reception of signals from radio transponders, which in some locations may be the primary means of stream delivery. As shown in FIG. 11, the audio transducer (162) and microphone (164) are preferably located diagonally opposite, allowing the unit to be held against the cheek when making or receiving telephone calls. Alternatively, a headset with a cord or small boom microphone may be plugged into the unit's audio jack (204), and used instead of the internal audio transducer and microphone. The unit preferably includes a keypad (161) with a standard telephony layout.

Other handset features include SMS, GPRS, a computer port, and TV reception. Viewing options may include an inbuilt screen, the ability to feed the baseband A/V signal to an external TV receiver, and the ability to modulate the baseband A/V signal onto a radio-frequency carrier and feed it to the antenna input of an external TV receiver of conventional design.

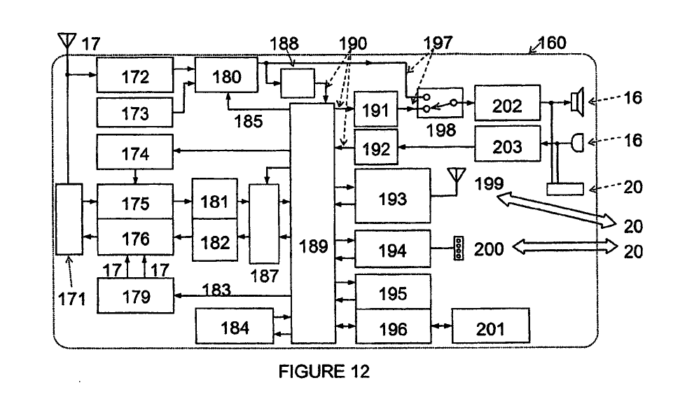

As shown in FIG. 12, handset operation is generally similar to that of the vehicle units described herein. Significant differences may include the provision of an inbuilt ferrite loop antenna (173) to enable reception on the medium frequency broadcast band; and the use of the Bluetooth wireless link (205) to receive services instead of delivering them.

Other handset versions include a-medium-range handset and a long-range handset, both of which include the capabilities of the standard handset versions disclosed herein, plus additional capabilities to allow them to be used in remote areas where short-range radio modems are not present. These versions are described in a subsequent section herein.

It is preferred that by entering an appropriate code into the keypad, two handsets of any version should be able to communicate directly with each other using Bluetooth, to permit intercom operation without going through the network. If an external telephone call arrives during an intercom session, it is preferably announced by a short background tone similar to the call waiting facility used in conventional handsets. Upon hearing the alert, the user can choose to take the call, or else ignore it and continue the intercom session. The Intercom mode may be limited to Bluetooth.

Handset Numbering Scheme

The ability of handsets to transfer seamlessly between Bluetooth and a radio modem enables a telephone call to commence inside a vehicle and continue while the user alights, walks down the street, enters his or her dwelling, and comes within range of the Bluetooth link belonging to a set-top-box (210) in said dwelling. In this example, the call would commence using the Bluetooth link to the vehicle unit, then be handed off to a radio modem in the street, and finally be handed off to the Bluetooth link belonging to the set-top-box. This blurring of the distinction between fixed and mobile telephony produces significant benefits.

First, it eliminates the need for a separate series of telephone numbers for fixed and mobile telephony. It allows any number of digits to be allocated to any handset, regardless of whether said handset is optimized for and used in the fixed, vehicular or portable role. In fact a distinction between fixed, vehicular and portable handsets would be irrelevant as far as the rest of this system is concerned, because the same signal path is used for all handsets, up to the point of connection to the user. This enables numbers to be allocated without reference to location, and also eliminates the need for area codes.

Second, it eliminates a security weakness with the present numbering system, which arises from the fact that the numbers for fixed telephones are tied to fixed locations. This makes it possible to ascertain whether dwellings are occupied by ringing said fixed telephone number. However with the system described herein, users may receive all telephone calls regardless of their location, thereby eliminating said security weakness.

Set-Top-Box Modem

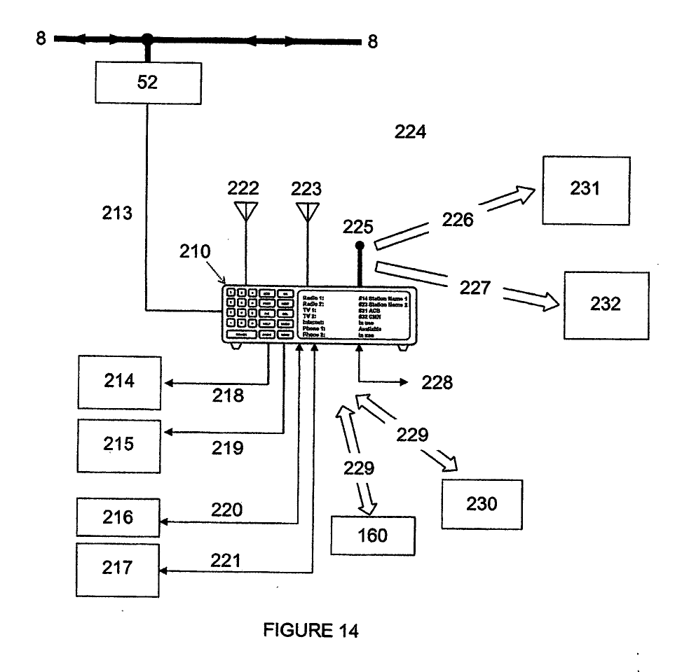

As shown in FIG. 14, fixed users in local service areas are connected by set-top-box (STB) modems (52) feeding set-top-boxes (210) located within the user's premises through coaxial cable (213). STB modems may be located near the user's premises and serve a single set-top-box, or distantly located and serve multiple set-top-boxes using a multiplex technique.

STB modems may also include circuitry to enable users to select services from third party providers sharing the local link (8), for example cable TV, cable Internet data, and telecommunications. If the user selects such a service, the modem preferably converts it into packets similar to those used by this system, to enable said services to be intermingled with those delivered by this system.

From the viewpoint of upstream hardware such as the gateway and routers, STB modems appear similar to radio modems (51), except that they can also deliver Internet video streams.

Set-Top-Box

General

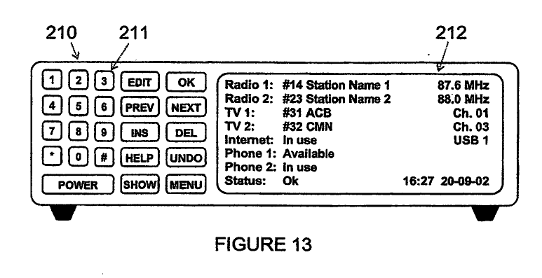

As shown in FIG. 13, the set-top-box (STB) (210) functions as a hub for the user's radio receivers (214) (231), TV receivers (215) (232), handsets (160), fixed telecommunications equipment (217), computing equipment (216), remote control unit or units (230), and external antennas (222) (223) for receiving free-to-air radio and TV signals. The STB should preferably be able to:
(a) receive Internet media streams from an STB modem and decode them;
(b) activate one or more internal receivers, tune them to free-to-air radio and TV signals, and demodulate them to audio or A/V as applicable;
(c) forward audio and A/V signals to the user's equipment using low-level audio or modulated RF signals;
(d) be able to deliver Internet data to an attached computer, which should preferably also be able to set up designated STB functions, and also function as an extended front panel for said STB;
(e) connect to one or more handsets via Bluetooth radio links (229), said handsets through the STB being able to make and receive telephone calls, send and receive SMS messages and other traffic, and preferably select and listen to Internet audio streams;
(f) be physically connected to fixed telecommunications equipment;
(g) be controlled by multiple remote control units.

The STB includes a keypad (211) and display (212) to enable the user to enter or edit URLs and free-to-air radio frequencies and TV channels, and also to set up other parameters required for correct operation. It accommodates multiple remote control units to allow independent selection of the desired URL, frequency or channel for each radio and TV receiver driven by the STB. The remote control units are not needed for Internet data or telecommunications.

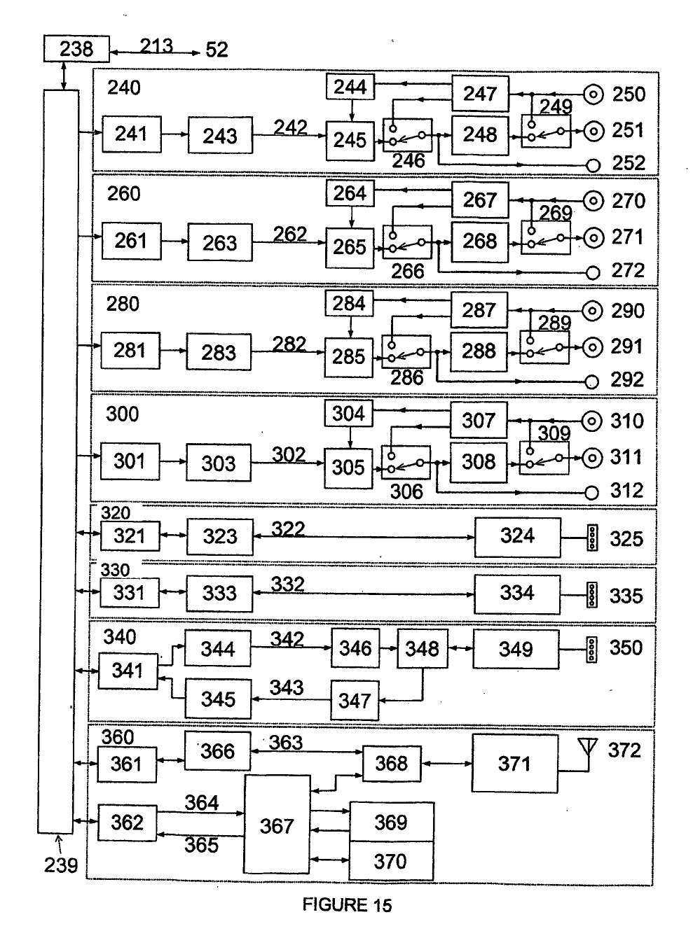

The STB preferably accommodates eight slide-in cards, each able to operate independently, to enable said STB to be customized to various user requirements. FIG. 15 shows a functional block diagram of an STB containing two Internet audio cards, two Internet video cards, two Internet data cards, one- card for fixed telecommunications, and one card for portable telecommunications and remote control using a Bluetooth wireless link.

Provision for Radio

Each STB audio card is able to store Internet URLs, issue the desired URL in response to a station select command from the user, and when the audio stream arrives from the gateway, decode it to baseband audio. To enable the reception of free-to-air radio signals, each card preferably also includes a free-to-air radio receiver that can receive both very-high frequency FM signals and medium frequency AM signals, and demodulate it to audio.

The desired audio signal is selected and directed either to a direct audio output (252) (272) for connection to an external amplifier, or else modulated onto a spare frequency using a low power frequency generator and modulator (248) (268). The modulated signals thus obtained may be fed either to coaxial connectors (251) (271) for distribution to the user's AM/FM radio receivers via coaxial cable, or else transmitted by a small antenna mounted on the STB (225). Provision for external antennas for the STB's internal free-to-air radio receiver is made by connectors (250) (270).

To listen to an Internet audio stream on an external AM/FM radio receiver, the user first tunes said receiver to a fixed frequency corresponding to the modulated RF signal emanating from the STB, and then selects the desired station using the remote control unit (230) to control the STB. If desired, presets for free-to-air stations can be intermingled with those for Internet audio streams, so that the changeover from one type of station to the other is transparent to the user. If a free-to-air station is selected, the audio card automatically selects the external antenna connector (250) (270) to maximize reception quality. Alternatively, the STB may contain an antenna splitter in lieu of an antenna switch.

Provision for TV

The provision for TV is similar to that for radio, except that the frequency of the low power TV modulator (288) (308) corresponds to a spare channel that is preferably in the UHF TV broadcast band. It is also preferred that the user is able to select the desired type of modulation, for example PAL, NTSC, or other desired format.

Provision for Internet Data

Each Internet data card removes packeting information added by the upstream part of this system, buffers and reformats the data signal to standard TCP/IP format, and presents it to a data transceiver (324) (334). The data transceiver is connected to data connector (325) (335), to which an external computer may be connected. The computer will therefore see the STB as a conventional data modem, similar to an ordinary ADSL modem.

Provision for Telecommunications

The fixed telecommunications card includes a hybrid (348), level converter (349) and connector (350) for connecting fixed telephone and facsimile equipment, and the portable telecommunications card includes a Bluetooth port (371) (372) to allow the use of any handset described herein, for example (160), and a remote control unit. It is preferred that the Bluetooth port accommodates multiple handsets and remote control units, all of which can be used simultaneously up to the limit set by the Bluetooth link or aggregate STB data rate.

Remote Control Unit

General Description

The remote control units (230) preferably use Bluetooth to control the STB, and infrared to control the user's radio and TV equipment. If the user uses the remote control unit to select an Internet media stream or send any other command recognized by the STB, the command is sent via the Bluetooth link (229) to the STB. If the user uses the remote control unit to adjust anything that is specific to his or her equipment, for example sound or picture characteristics belonging to a conventional radio or TV receiver, the command is sent via the infrared link directly to said equipment.

Because the user's equipment may be in more than one room, the system preferably accommodates multiple remote control units, each of which is customizable to a particular piece of equipment and which can be used independently. The remote control units preferably include an LCD screen which is able to display station details, program and content information, and any other information considered useful.

Customization

Before first use, the infrared commands for each remote control unit must be customized for the equipment to be controlled. This may be performed in various ways, such as activating a configuration menu on the STB and entering details of the equipment to be controlled causing the STB to forward the details to the gateway, or by logging onto the system website (39) and selecting from a list of equipment brands and type numbers. Upon receiving the equipment details, a server at the gateway may look up the settings for said equipment in a database and download them through the system to the user's STB. Upon receiving these settings, the STB then forwards them to the remote control units via its Bluetooth link.

Another method is to point the remote control unit at the one provided with the user's equipment, and selecting learn mode wherein by pressing pairs of buttons, commands from the user's remote control unit may be transferred to the remote control unit disclosed herein. This mode may be useful for equipment not listed in the database at the gateway.

To allow a single remote control unit to control more than one item of equipment, remote control units may include “hotkeys” to quickly change from one customization to another. The display may show the name associated with the current customization. It is preferred that the remote control units also be able to save sequences of key presses as macros.

Group Repeater

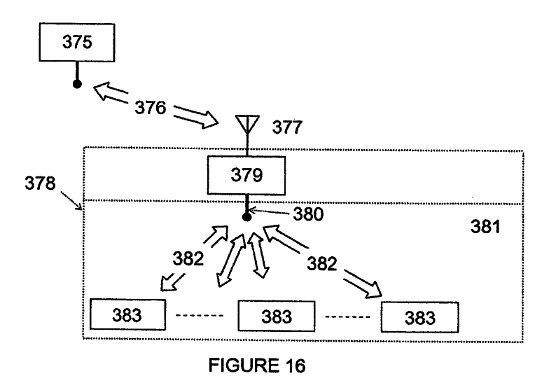

FIG. 16 shows a group repeater (379) that may be used to connect handsets belonging to passengers in commuter vehicles. The purpose of these repeaters is to overcome the shielding effect of the vehicle and external environment such as railway tunnels, which could make it difficult for said handsets to maintain reliable connections with radio modems outside the vehicle. Group repeaters operate by establishing a group of two-way radio connections with radio modems outside the vehicle, said group being sufficient to provide each person inside the vehicle with the service of their choice. The connections to users inside the vehicle are made using one or more multiplexed Bluetooth signals.

Group repeaters may also provide coverage to areas inside buildings and other communal areas such as shopping centers that are beyond the reach of nearby radio modems, and where the installation of additional optical fibers and modems may be impractical or uneconomic.

Group repeaters preferably provide each person in the compartment or area with a separate full speed Internet audio stream. To avoid signal dropouts due to multipath inside the compartment or area, it is preferred that the Bluetooth link uses frequency diversity.

To avoid dropping streams if a heavily populated compartment moves into an area of insufficient modem capacity, it is preferred that group repeaters employ a voting scheme to determine which streams are delivered to said compartment. In such a scheme, Internet media streams are allocated to pre-determined categories, and delivered according to the number of requests by people using that particular group repeater. If a user requests a stream that is below the threshold of popularity in its allocated category, it is preferred that he or she be offered a choice of alternatives in the same category, which are above the threshold of popularity.

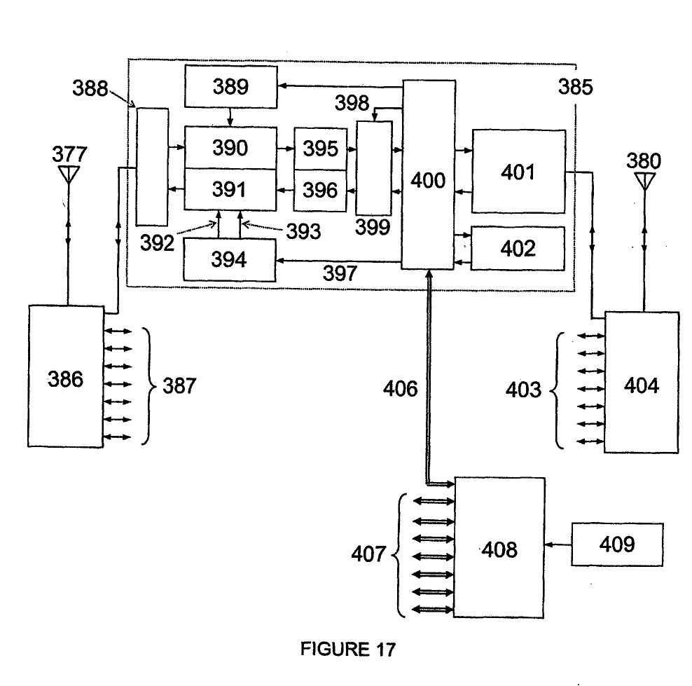

FIG. 17 shows a functional block diagram of an eight channel repeater. For more than eight channels, separate group repeaters with separate antennas (377) are preferred. These repeaters preferably share a common frequency reference, and also obtain the spreading codes from a common pool (409) to ensure orthogonality. Each channel operates in a generally similar manner to the vehicle unit (80), with the Bluetooth port being provided by antenna (380).

Remote Links

Satellite Transceiver (Gateway Version)

Each gateway may feed a transceiver means (35) of transmitting data and traffic to users in remote areas and receiving data and traffic from said users, said data and traffic including Internet media streams, Internet data, telecommunications and system commands, said traffic being relayed in both directions by satellite transponder means (417). To maximize the number of users which may be serviced without exceeding the capacity of the satellite transponder means, it is preferred that the bandwidth or data rate per user be flexibly allocated.

To alleviate the possibility of a remote link being unable to supply all requested streams, it is preferred that the gateway employs a voting scheme to automatically determine which streams are delivered to the remote link. It is further preferred that this voting scheme relies upon Internet media streams being allocated to pre-determined categories, and that voting occurs within each category, such that a minimum level of choice exists at all times across the range of categories. It is further preferred that if a remote user requests a stream which is below the threshold of popularity for sending through the link, he or she be offered a choice of other streams in the same category which are above the threshold, and therefore meet the criteria for delivery.

To improve redundancy and flexibility, it is preferred that more than one gateway be equipped for satellite transmission and reception.

Satellite Transponder

In the downstream direction, one type of satellite transponder (417) may relay narrowband traffic including Internet audio, Internet data, telecommunications and system commands, and another type of satellite transponder (417) may relay wideband traffic including Internet video. In the upstream direction, a third transponder may be relay narrowband traffic including that generated by users and that generated by downstream equipment which is part of the system.

Satellite Transceiver (Private Use)

It is preferred that satellite transceivers for private use (431) include a means of receiving a satellite downlink signal containing at least one Internet audio stream, telecommunications channel and Internet data channel, together with necessary system commands. It is further preferred that this transceiver include an additional means of receiving a satellite downlink signal sufficient to accommodate at least one Internet video stream. It is further preferred that this transceiver include an additional means to transmit at least one telecommunications channel and Internet data channel, together with data generated by downstream equipment, up to a satellite transponder.

This transceiver is connected to the high-speed data bus (432) of a long-range set-top-box (437), said bus conveying services, data and commands between all devices connected to the bus.

Satellite Transceiver (Public Use)

It is preferred that a satellite transceiver for public use (551) is similar to that for private use, except that it possesses sufficient capacity to provide a separate Internet audio stream, Internet data channel or telecommunications channel to multiple users, the number of multiple users being equal to that serviced by the relay site described herein. It is further preferred that this transceiver include an additional means of receiving a satellite downlink signal sufficient to accommodate one or more Internet video streams, for relaying to users via a locally connected TV transponder, if they are within range of said TV transponder.

Long-Range Set-Top-Box

It is preferred that the long-range set-top-box for private use (437) is similar to a standard set-top-box (210), except that the user side communicates over a high-speed data bus (432) which preferably uses a standard protocol. This bus provides a means of peer-to-peer transfer of services; data and commands between all equipment connected to the long-range set-top-box, which may be managed by said long-range set-top-box.

The long-range set-top-box includes a Bluetooth radio link (447) to wirelessly connect the various handset versions (160) (453) (456) and also remote control units (446). The long-range set-top-box includes a means of assessing signal strength and channel quality, so that if a handset moves out of range of its Bluetooth link, said long-range set-top-box hands communications off from said Bluetooth link to a local transceiver (451) or long-range transceiver (449) depending on the type of handset and distance.

The long-range set-top-box may also be connected to a second long-range set-top-box using a cable or bus extender (452), to allow two long-range set-top-boxes to share a single satellite antenna (430) and transceiver (431)

Local Transceiver

The local transceiver (LT) (451) is a low power duplex UHF transceiver, which provides a means of communication with a medium-range handset (453) or a long-range handset (456) that is outside the range of the Bluetooth radio link (447) belonging to a long-range set-top-box. The maximum communication range of an LT depends on its transmitter power, but is preferably at least 1 km. The radio link is digitally encrypted. The LT does not communicate with a standard handset (160), due to the lack of suitable UHF capability in said standard handset.

The LT is connected to the high-speed data bus (432) of a long-range set-top-box, said bus conveying services, data and commands in both directions. The LT preferably operates with an omnidirectional UHF whip antenna, which may be mounted on its case.

Long-Range Transceiver

General

The long-range transceiver (LRT) (449) is a duplex or quasi-duplex medium power HF/UHF transceiver, which provides a means of communication with long-range vehicle units (457) and long-range handsets (456). The maximum communications range depends on transmitter power, antenna characteristics and propagation, but in good conditions may extend to several hundred km. One LRT is required for each long-range vehicle unit or long-range handset.

If signals are strong and channel quality is good, the LRT automatically uses UHF. If signals are too weak or channel quality too poor for UHF, the LRT automatically changes to HF. The method of establishing a UHF or HF link is described in the section titled “Automatic Link Establishment”.

The LRT is connected to the high-speed data bus (432) of a long-range set-top-box, said bus conveying services, data and commands in both directions.

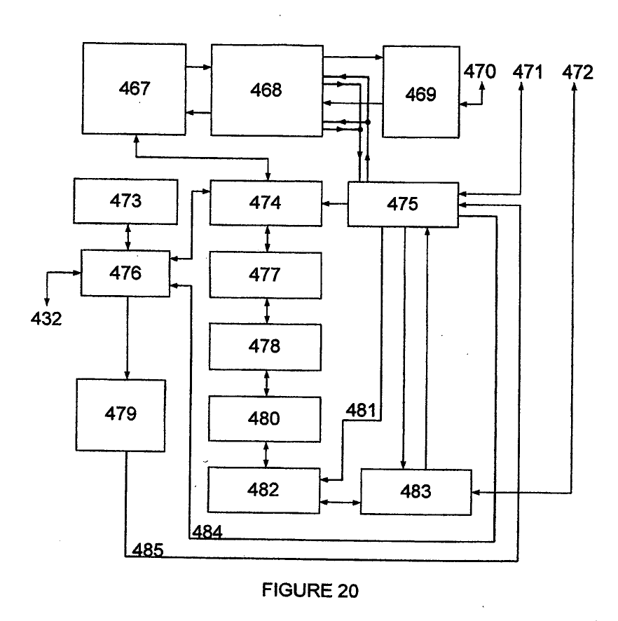

Referring to FIG. 20, the high-speed data bus contains address information, digitized audio, and type of service. The input/output (476) extracts audio addressed to the LRT and passes it to the audio switch (474) for routing to either the UHF or HF section of the transceiver as required.

Signals that are routed to the UHF section are processed as follows. Telecommunications signals may bypass the digital encryption unit (467), because they are already encrypted. Internet audio streams and Internet web pages may be low-grade encrypted by (467), sufficient to protect privacy. Email may receive high grade encryption. The signal is then shaped and passed to the UHF transceiver (468) for transmission.

Signals that are routed to the HF section are processed somewhat differently in order to achieve quasi-duplex operation, an implementation of which operates as follows. Internet audio streams are analog encrypted (480), and then broken into a series of blocks with silence in between by the “block time compandor” (482). These blocks are then applied to the HF transceiver (483). Internet audio and Internet data bypass the A5 encryption device (477), and Internet data bypasses the block time compandor (482).

Although the ultra-high frequency transceiver preferably handles data at the same rate as a standard vehicle unit, spectrum limitations applying at high-frequency effectively prevent the transmitted high-frequency signal exceeding three to five kHz bandwidth. Although this is acceptable for telecommunications and moderately acceptable for data, it will noticeably limit the quality of music delivered by an Internet audio stream. However there is no practical alternative for long-distance delivery, and in practice the quality could equal or surpass that of a weak medium-frequency AM station which is received over a long distance.

The central processor (475) monitors signal strength and channel quality, processes gateway commands and user requests, calculates the expected signal strength according to frequency, controls the transceivers (468) (483), controls and monitors the antenna tuning unit (471), and performs other necessary supervisory and control functions.

On HF, the LRT automatically reduces the output power to the lowest level that provides acceptable channel quality, to minimize interference to other users.

The HF section (483) of the LRT preferably operates in conjunction with an antenna optimized for near-vertical incidence skywave, such as an HF delta. The UHF section of the LRT preferably operates in conjunction with an elevated omnidirectional whip.

To minimize the UHF feedline loss, it is preferred that the LRT front panel be removable, to enable the LRT to be located close to the antenna, and the front panel to be conveniently located for the user. When removed in this manner, it is preferred that the front panel and the LRT communicate with each other via the high-speed data bus (432).

Group Broadcast and Intercom Modes

Where a user has more than one LRT, said LRTs must operate on different frequencies in order to supply independent services to outlying users. However there may be occasions when outlying users wish to share the same transmission from an LRT, or else communicate directly with each other. These modes are called group broadcast and intercom respectively.

To achieve group broadcast mode, the outlying receivers are automatically tuned to the same frequency. The associated transmitters are also tuned to the same frequency, and set to voice operated transmit to allow voice break-in. The broadcast is channeled through a single LRT.

To achieve intercom mode between two outlying users, the HF receive and transmit frequencies of both users are automatically set to be the same, and the UHF receiver of one user is automatically tuned to the UHF transmitter of the other user and vice versa.

To operate in these modes, the equipment needs a common encryption key, and also be synchronized as a group.

Bus Extender

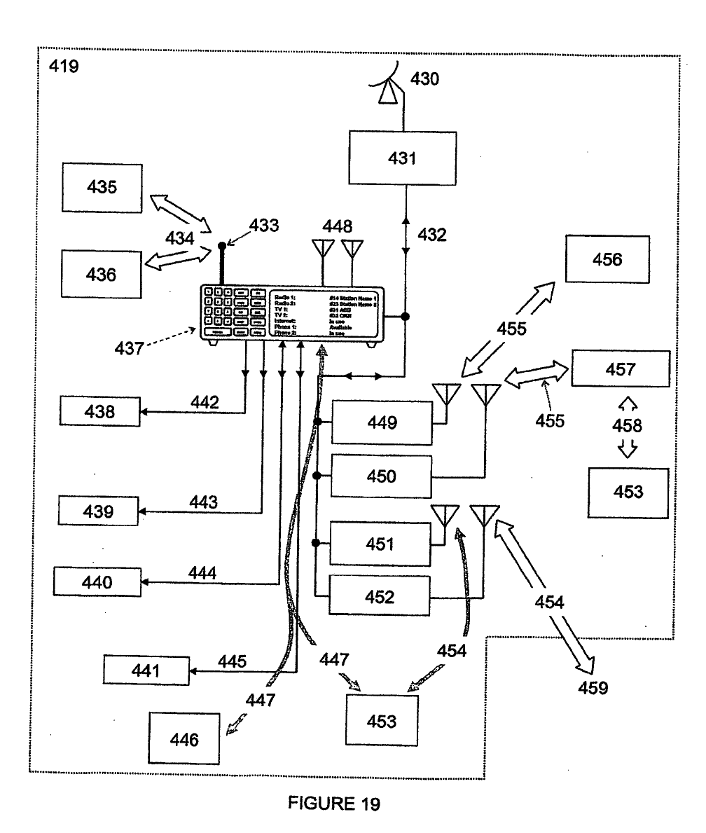

The bus extender (452) is a low power duplex UHF transceiver, which allows two or more long-range set-top-boxes to share a single satellite transceiver as shown in FIG. 19. The bus extender preferably has sufficient bandwidth to convey at least one of each service, which include Internet audio, Internet video, Internet data, and telecommunications. The link is encrypted. Local spectrum regulations may require the bus extender to operate in conjunction with a narrow beamwidth antenna such as a Yagi, to minimize the risk of interference to other spectrum users.

Medium-Range Handset

The medium-range handset (453) possesses the general capabilities of a standard handset, with the addition of a duplex UHF transceiver. Said duplex UHF transceiver operates similarly to a local transceiver (451), and preferably comprises a repackaged version of said local transceiver.

Upon switch-on and occasionally thereafter, the medium-range handset initially searches for a Bluetooth signal from a compatible device belonging to this system. If it finds a Bluetooth signal of sufficient strength and quality, it automatically establishes a Bluetooth radio link with said device. If it is unable to find a Bluetooth signal of sufficient strength and quality, it then searches for a signal from a radio modem. If it finds one of sufficient strength and quality, it automatically establishes a wireless link with said modem. If it is unable to find a modem signal of sufficient strength and quality, the handset activates its internal UHF transceiver and searches for a signal from a compatible device belonging to this system, such as a local transceiver. If it finds a UHF signal of sufficient strength and quality from said compatible device, it automatically establishes a UHF link with said device.

The medium-range handset preferably uses a case-mounted UHF antenna.

Long-Range Handset

The long-range handset generally possesses the capabilities of a medium-range handset, with the addition of a duplex UHF/HF transceiver. This additional transceiver operates similarly to a long-range transceiver (449), and preferably comprises a repackaged version of said long-range transceiver.

Signal acquisition is initially the same as a medium-range handset. If this acquisition fails, and the long-range handset cannot establish a satisfactory UHF link, it then activates its internal HF transceiver and searches for an HF signal from a compatible device belonging to this system, such as a long-range transceiver, or similar equipment in a relay site. If it finds an HF signal of sufficient strength and quality from said compatible device, it automatically establishes an HF link with said device. The establishment and maintenance of the HF link is similar to that described in “Automatic Link Establishment”.

The UHF frequency corresponds to that of a long-range transceiver, not a local transceiver, which will normally use different frequencies. For greater flexibility, the long-range handset may therefore include a means of changing the UHF frequency between that belonging to a long-range transceiver, and that belonging to a local transceiver.

The long-range handset requires an HF antenna preferably optimized for near-vertical incidence skywave, such as a low horizontal element or HF delta. The handset also requires a UHF antenna, which may be an omnidirectional whip.

Long-Range Vehicle Unit

General

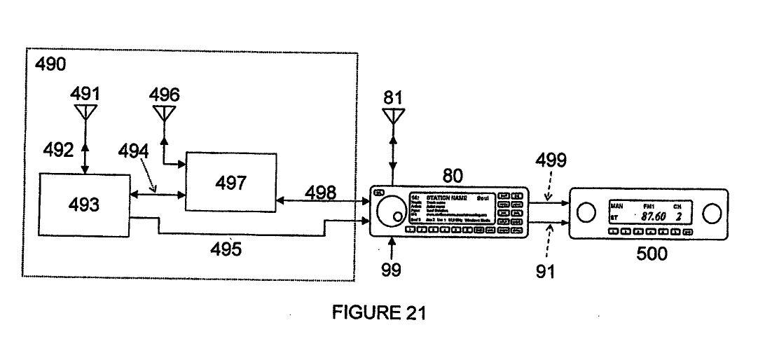

The long-range vehicle unit (423) (457) 564) comprises a standard vehicle unit (80) fitted with additional items (490) including a long-range adaptor (497), antenna tuning unit (493), high-frequency vehicular antenna (491), and ultra-high frequency vehicular antenna (496). These additional items provide the ability to remain connected to the system when traveling in remote areas that are devoid of radio modems, using ultra-high frequency radio for medium distances, and high-frequency radio for long distances. To further increase utility, the long-range adaptor includes an additional low-power ultra-high frequency transceiver, to relay services to a medium-range handset that is taken some distance away from the vehicle, preferably a kilometer or more. The changeover between the various frequencies is determined by several factors, which may include channel availability, signal strength and channel quality. FIG. 21 shows the configuration of a long-range vehicle unit.

Long-Range Adaptor

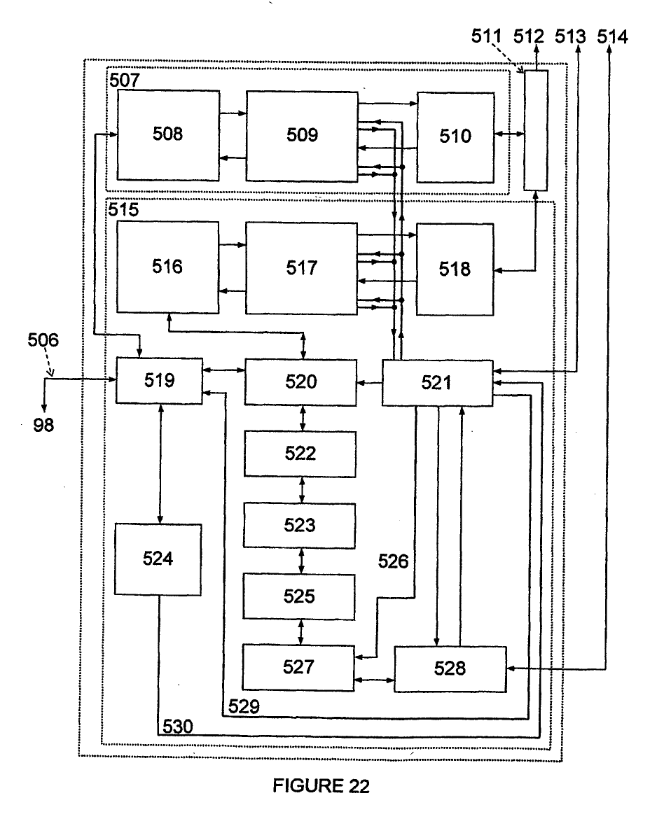

FIG. 22 shows the long-range adaptor. This includes a duplex UHF transceiver (509) and a simplex HF transceiver (528), which provides a means of communicating with an LRT at medium to long distances. These items operate similarly to the corresponding sections of an LRT.

The long-range adaptor also includes a second duplex UHF transceiver (517), which provides a means of communicating with a medium-range handset up to a km or more away. This transceiver is similar to an LT, but differently packaged. It operates similarly to a Local Transceiver.

The long-range adaptor includes antenna diplexers (510) (518) (512) to allow both UHF transceivers to operate simultaneously. The high-speed data bus (506) is connected to the input/output expansion port (98) of a vehicle unit, said port providing the means of transferring all services, data and commands between the adaptor and the host vehicle unit. The long-range adaptor can also control an antenna tuning unit (493).

Upon switch-on and occasionally thereafter, the host vehicle unit searches for a signal from a radio modem. If it finds a modem signal of sufficient strength and quality, it ensures that any long-range adaptor that might be connected is deactivated, and automatically establishes a short-range radio link with said modem. If it is unable to find a modem signal of sufficient strength and quality, it deactivates its RF front-end and commands the long-range adaptor to become active.

When the long-range adaptor becomes active, controller (521) causes transceiver (509) to search for a UHF signal from an LRT. If it finds a UHF signal of sufficient strength and quality from an LRT, it performs a handshaking sequence in which each unit attempts to authenticate the other unit, and if authentication is successful, transceiver (509) establishes a UHF radio link with said LRT. If it is unable to find a UHF signal of sufficient strength and quality, or if authentication fails, the adaptor deactivates transceiver (509), activates HF transceiver (528), and searches for an HF signal from an LRT. If it finds an HF signal of sufficient strength and quality from an LRT, it performs a handshaking sequence in which each unit attempts to authenticate the other unit, and if authentication is successful, said transceiver (528) establishes an HF radio link with said LRT. HF link establishment is further described in the section herein titled “Automatic Link Establishment”.

Antenna Tuning Unit

The antenna tuning unit (ATU) (493) provides the means of tuning and matching the high frequency vehicular antenna (491) to the HF transceiver (483) contained in the long-range adaptor (497). The ATU, or a version thereof, may also be used in fixed installations to tune the high-frequency antenna associated with a long-range transceiver (449) (553) or version thereof (573) (588).

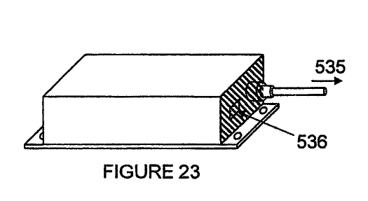

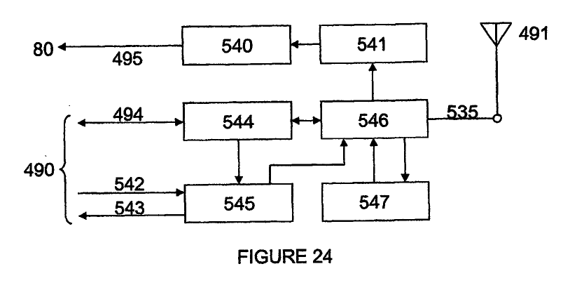

The ATU is preferably able to be pre-tuned prior to transmission, according to settings stored in non-volatile memory (547). After transmission commences, the central processor (545) monitors the reflected power using a directional coupler means (544), and adjusts the tuning and matching circuitry (546) until the reflected power at the transmitter port (494) is minimized or preferably zero. The means of tuning and matching may be provided by series and shunt reactive elements, and possibly transformers, which are switched in and out using relays or other devices. FIG. 23 shows a physical representation of the ATU, and FIG. 24 an internal block diagram.

The ATU preferably includes a frequency splitting network (541), and if necessary a high frequency bandstop filter (540), to allow the vehicle unit (80) to receive signals on the medium-frequency AM broadcast band and the very-high frequency FM broadcast band.

High-Frequency Vehicular Antenna

The high-frequency vehicular antenna (491) is required to operate with reasonable transmit efficiency over the frequency range used by the high-frequency transceiver (483) belonging to the long-range adaptor, and is preferably optimized for near-vertical incidence skywave (NVIS) propagation. Prospective antennas for vehicular use include an inclined whip, and a roof-mounted horizontal element. The antenna may include frequency selective networks to enhance reception on the medium-frequency and/or very-high frequency broadcast bands.

Vehicular UHF Antenna

The ultra-high frequency vehicular antenna (496) is preferably an omnidirectional whip mounted high on the vehicle, for example on the roof, gutter, or windscreen.

Remote Links (Public Use)

Access via Private Facility

The long-range vehicle units and long-range handsets disclosed herein are preferably able to transmit an alert signal on a high-frequency paging channel, the purpose of which is to request emergency access to a private facility.

The owner of a private facility is preferably able to set his or her equipment to accept or reject such access requests, or to alert said owner. If the request is granted, it is preferred that the owner retains priority, if he or she so desires.

Access via Isolated Modem/s

In remote areas, to provide local access where people tend to congregate, a satellite transceiver capable of handling multiple channels of Internet audio, Internet data and telecommunications is preferably installed to feed one or more local radio modems (51), said modems allowing standard vehicle units and handsets to be used in their vicinity. In like manner, a satellite transceiver capable of handling Internet video streams preferably feeds a media transponder for TV (53), said transponder allowing Internet video streams to be received and viewed by users in the vicinity as disclosed herein.

Access via Relay Site

To deliver services to travelers and other itinerant users in remote areas, relay sites are preferably installed across such areas in a grid formation. These sites preferably include a satellite transceiver (551) or modem (558) capable of relaying at least four independent narrowband channels, and one long-range transceiver version per channel (553) (554) (555) (556). Users will need a long-range vehicle unit or long-range handset to access relay sites.

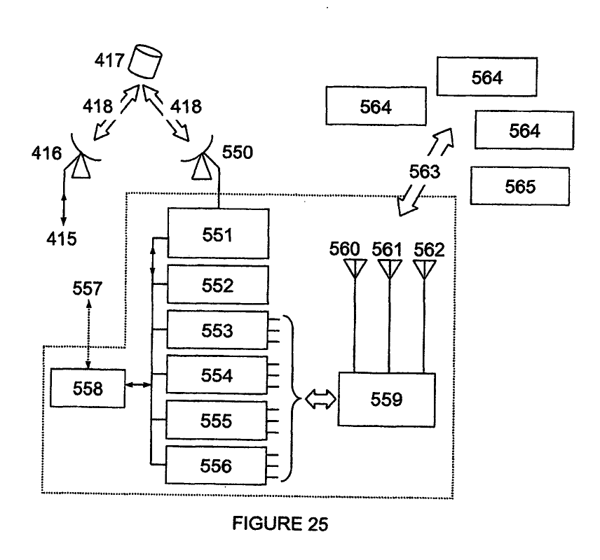

Relay sites include a system controller (552), which may be a cut-down version of the controller used in the long-range set-top-box disclosed herein. For equipment commonality purposes, it is preferred that relay sites use a similar bus to a long-range set-top-box. FIG. 25 shows the general configuration of a relay site.

The HF section of a relay site preferably operates in conjunction with an antenna suitable for near-vertical incidence skywave (NVIS), such as an HF delta or similar antenna. Separate antennas may be used for transmit and receive. The UHF section of the relay site preferably operates in conjunction with an elevated omnidirectional whip.

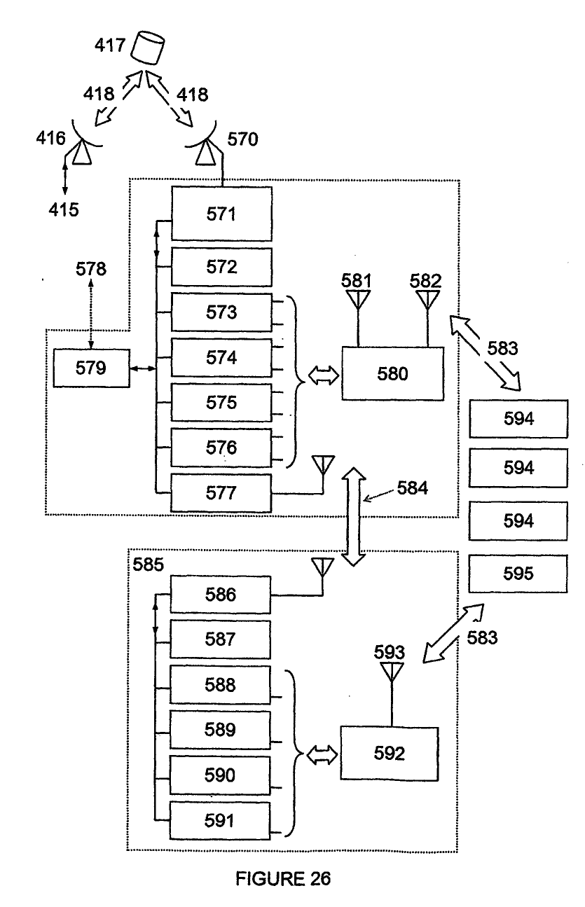

FIG. 26 shows a version of the relay site that uses separate transmit and receive sites for HF, to alleviate co-siting problems. In this example, the transmit and receive sites are wirelessly connected using bus extenders (577) (586), and the unused HF receive and transmit sections are eliminated from the LRTs.

Aircraft Passengers

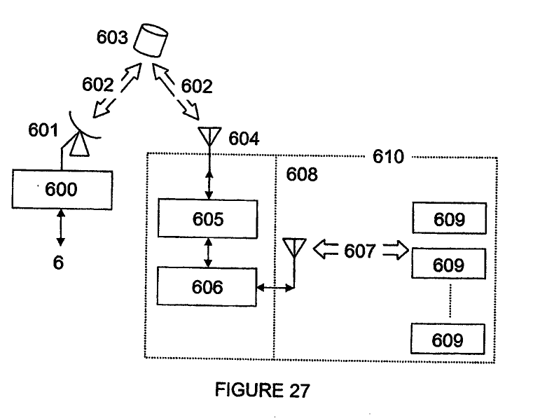

As shown in FIG. 27, to deliver services to passengers in an aircraft (610), one or more gateways preferably feed satellite transceivers (600) capable of delivering multiple channels to a satellite transponder (603), said transponder possessing a footprint that covers the flight path of the aircraft.

The satellite downlink (602) is received by an omnidirectional or electrically steered antenna (604), which feeds a satellite transceiver (605). The transceiver is connected to group repeater (606), which translates all services, data and commands to a form suitable for transmission to passengers in the aircraft using a Bluetooth wireless link (607). To use these services, said passengers may use any of the handsets described herein that possess Bluetooth capability (609), or similar devices provided by the airline.

Quasi-duplex

This section only applies to HF.

Due to the requirement for frequency agility, it would be very expensive to build duplex transceivers for both ends of the link, where the same antenna is used for transmit and receive. Such transceivers would be complex, power hungry, less reliable, and likely to suffer from noisy and blocked receive channels. A viable alternative is to use simplex transceivers, which alternately transmit and receive on the same channel.

Because good analog encryption employs time interleaving, which causes the gaps between words to become filled in, the output signal is (or should be) spectrally similar whether or not audio traffic is being passed. This makes it incompatible with voice operated transmit (VOX), because there are no gaps in the modulating signal to allow periodic changeovers from transmit to receive. Therefore for both Internet audio and telecommunications, the transmitter digitizes the encrypted audio signal, forms it into blocks, re-clocks the blocks to speed them up slightly, and converts the blocks back to analog. This has the effect of splitting up the audio into fixed length segments, at a slightly higher pitch and tempo, with short periods of silence between each segment. During these silent periods, the transmitter switches to receive and listens for a special interrupt code from the user. If none is received, it switches back to transmit and sends the next segment.

At the receiving end, the demodulated audio is similarly processed, except that the blocks are slowed down and rejoined. Providing the transmitter and receiver are properly synchronized, the resulting signal has no audible disruption.

If the user at the receiving end speaks during a telephone conversation, his equipment sends an interrupting code to the transmitting end during one of the silent periods. If the transmitting end receives this code, it stops sending. This allows the person who was speaking to hear the interruption and pause naturally. The effect is similar to normal VOX.

To avoid the possibility of both users speaking continuously at the same time, causing the system to rapidly shuttle back and forth, algorithms at each end monitor the number of break-in attempts, so that if they detect an extended period of contention, they assert the channel in one direction or the other.

If the interrupt is sent because the user selects a different station or service, the interrupting code may be followed by data and checkbits. The transmitting end pauses as before, allowing this lengthier code to be received, which includes details of the required station or service. After validating the request by comparing it against the checkbits, and possibly by performing a handshake routine, the transmitting end forwards the request to the gateway.

Because Internet data is normally sent as TCP/IP packets, it is straightforward to periodically change over to receive for short periods between said TCP/IP packets, to allow the other party to break in. In this case the receiver synchronizes itself to the transmitted TCP/IP packets, so that it knows exactly when to break in. The time compression technique referred to above is therefore not necessary in this case.

Automatic Link Establishment

New Session

In the absence of traffic, the long-range transceiver (LRT) continuously monitors the allocated UHF channel and scans the HF paging channels. The HF paging channels are shared channels, used for signaling only, which are spaced across the HF operating frequency range.

To commence a new session, a long-range vehicle unit or long-range handset, herein called an outlying unit, transmits a request on a UHF paging channel. If the LRT receives this request, it checks its database and performs a handshaking routine to see if the outlying unit is authorized. If it finds the outlying unit is authorized, the LRT sends an acknowledgement to said outlying unit, and forwards the request to the gateway. The gateway responds by allocating the required service, which the LRT forwards to the outlying unit.

If the outlying unit does not receive a response, indicating that it is outside the range of the UHF link, it tries again a predefined number of times. If there is still no acknowledgement, it then attempts to determine the most likely HF paging channel, and resends the request there. This channel is determined from an algorithm based on the time and frequency of the most recent HF session, current time and date.

If the outlying unit fails to receive an acknowledgement on said HF paging channel, it switches to the next HF paging channel and repeats the process, cycling through each HF paging channel until it receives an acknowledgement. When the LRT receives the request, it proceeds as for UHF, except that the service is transferred to an HF channel nominated by the FMS.

Modify Session

If traffic is already being passed, and an outlying user wishes to change station or service, his unit requests the appropriate station or service on the current channel, which may be either UHF or HF. Upon receiving and verifying this request, the LRT sends an acknowledgement to the user and forwards the request to the gateway. The gateway responds by allocating the required station or service that the LRT forwards to the user.

Check Link

If an HF link is open but not passing traffic, the LRT may periodically ‘ping’ the outlying unit and listen for a response, to see if the path is still open. If the LRT fails to receive a response after a specified number of pings, it assumes that the path has closed or interference exists. It then notifies the gateway and reverts to the idle state. To minimize interference to other users, pings may be granted specific time slots by the FMS.

It can be seen that the invention provides an improved overall system for delivering broadcast and communications services. In particular it allows delivery of Internet media streams including Internet audio streams and Internet video streams, Internet data including the world-wide-web and email, and telecommunications. It should be understood that other variations to the invention which are readily understood by a person skilled in the art without any inventiveness is included within the scope of this invention. In particular the above is a description by way of illustration only and the scope of the invention is as defined broadly in the following claims.

### Appendix A

1 Internet
2 External telecommunications networks
3 Internet media streams means
4 Internet data
5 Telecommunications
6 Gateway
7 Trunk to other gateways
8 Local links
9 Remote area links devices
10 Local service area
11 Remote area
14 Loopback Means
15 Uniform resource locator (URL) predictor, register and generator
16 Multiple servers (for Internet media streams)
17 Multiple servers (for Internet data)
18 Telephone network interface
19 External gateway server
20 System software server
21 Master clock generator
22 Buffering and re-clocking devices
23 Address generator
24 Non-blocking matrix switch or routing
25 Virtual user ports
26 Service identifier
27 Packeting and de-packeting devices
28 Main processor
29 Multiplexing and demultiplexing
30 System supervisor
31 Encryption and decryption devices
32 Router and modem controller
33 Engineering interface
34 Frequency management sub-system
35 Satellite transceiver or transceivers
36 Home location register
37 Diagnostics
38 Visitor location register
39 Customer website
40 Customer records and billing
41 Customer dial-in service
42 Data from ionospheric sounders
50 Router
51 Radio modem
52 Set-top-box modem
53 Media transponder (radio or TV)
54 Short-range radio links
55 Handsets or vehicle units
56 Catenary wire
57 Baseband interface
58 Antenna
59 Hook
60 Hose clamp
61 Utility pole
62 Front view of modem
63 Side view of modem
65 Baseband interface
66 Multiple stream decoder
67 Frequency modulated exciter (one per stream)
68 Radio frequency combiner
69 Radio frequency power amplifier
70 Very high-frequency antenna
71 Frequency control line
72 Multiple frequency generator
77 Station selection knob
78 Display
79 Keypad or buttons
80 Vehicle unit
81 Modem antenna
82 AM/FM antenna
83 TV antenna
84 Low-level radio-frequency signal (Internet TV or video stream and free-to-air TV)
85 Antenna input on vehicular TV receiver
86 Vehicular TV receiver
87 Low-level audio/visual baseband signal
88 Unspecified audio/visual equipment
89 Low-level radio-frequency signal (Internet radio or audio stream and free-to-air radio)
90 Antenna input on radio receiver
91 DC power output to external radio receiver
93 External radio receiver
94 Low-level audio signal
95 Unspecified audio equipment
96 High-level audio signal
97 External speakers
98 Input/output expansion port
99 DC power input
100 Bluetooth wireless link (101), data connection (102), or infrared link (103)
101 Bluetooth wireless link
102 Data connection
103 Infrared link
104 External computer
105 Handset
110 Diplexer
111 Bandwidth control
112 Receiver
113 Transmitter
114 Receive local oscillator signal
115 Transmit local oscillator signal
116 Frequency generator
117 Internal TV receiver
118 Internal radio receiver
119 Bandwidth control line
120 Baseband modem (receive)
121 Baseband modem (transmit)
122 CDMA spreading code
123 Receive and transmit buffers
124 High-speed data transceiver
125 Encryption and decryption key
126 Encryption and decryption device
127 Analog to digital converter (TV)
128 Analog to digital converter (radio)
129 Programmable logic device or other processing device
130 DC power to internal circuits
131 Digital TV baseband signal
132 Analog audio baseband signal
133 Audio/visual codec
134 Audio codec
135 Bluetooth transceiver
136 Data transceiver
137 Infrared transceiver
138 Station memory
139 System controller
140 DC power switch
141 Analog TV baseband signal
142 TV signal switch
143 Audio signal switch
144 Frequency generator and TV modulator
145 Frequency generator and audio modulator
146 Audio amplifier
147 Bluetooth antenna
148 Data connector
148 Infrared emitter and detector
150 Keypad, display and beep
151 DC current sensing circuit
160 Handset
161 Keypad or buttons
162 Acoustic transducer
163 Display
164 Microphone
170 Whip
171 Diplexer
172 Low pass filter
173 Ferrite rod antenna (MF broadcast band)
174 Bandwidth control
175 Receiver
176 Transmitter
177 Receive local oscillator signal
178 Transmit local oscillator signal
179 Frequency generator
180 Internal radio receiver
181 Baseband receive modem
182 Baseband transmit modem
183 CDMA spreading code
184 Receive and transmit buffers
185 Frequency control line
186 Encryption and decryption key
187 Encryption and decryption device
188 Analog to digital converter
189 Programmable logic device or other processing device
190 Digital audio signal
191 Audio codec
192 Analog to digital converter
193 Bluetooth transceiver
194 Data transceiver
195 Station memory
196 System controller
197 Analog audio signal
198 Audio signal switch
199 Bluetooth antenna
200 Data connector
201 Keypad, display and beep
202 Audio amplifier
203 Audio amplifier
204 Audio jack
205 Bluetooth wireless link
206 Data connection
210 Set-top-box
211 Keypad or buttons
212 Display
213 Coaxial cable
214 External radio receiver
215 External TV receiver
216 External computer
217 External fixed telephony or facsimile equipment
218 Low-level signal (audio or modulated radio frequency)
219 Low-level signal (audio/visual or modulated radio frequency)
220 Data connection
221 Telephone conductor
222 User's radio antenna
223 User's TV antenna
224 Boundary of user's premises
225 Set-top-box antenna
226 Low power radio link (VHF FM)
227 Low power radio link (UHF TV)
228 Expansion input/output port (reserved)
229 Bluetooth radio links
230 Remote control unit or units
231 External portable radio receiver
232 External portable TV receiver
238 Decoder
239 Multiplexer/demultiplexer
240 Radio card (first instance)
241 Packet router
242 Radio stream (digital)
243 Data buffering and re-clocking device
244 Analog to digital converter
245 Audio codec
246 Signal switch
247 Internal radio receiver
248 Frequency generator and audio modulator
249 Signal switch
250 External radio antenna
251 Low-level radio-frequency output to external radio receiver
252 Low-level audio output
260 Radio card (second instance)
261 Packet router
262 Radio stream (digital)
263 Data buffering and re-clocking device
264 Analog to digital converter
265 Audio codec
266 Signal switch
267 Internal radio receiver
268 Frequency generator and audio modulator
269 Signal switch
270 External radio antenna
271 Low-level radio-frequency output to external radio receiver
272 Low-level audio output
280 TV card (first instance)
281 Packet router
282 TV stream
283 Buffering and re-clocking device
284 Analog to digital convertor
285 Audio/visual codec
286 Signal switch
287 TV receiver
288 Frequency generator and TV modulator
289 Signal switch
290 External TV antenna
291 RF output to external TV receiver
292 Low-level audio/visual output
300 TV card (second instance)
301 Packet router
302 TV stream
303 Buffering and re-clocking device
304 Analog to digital converter
305 Audio/visual codec
306 Signal switch
307 TV receiver
308 Frequency generator and TV modulator
309 Signal switch
310 External TV antenna
311 RF output to external TV receiver
312 Low-level audio/visual output
320 Internet card (first instance)
321 Packet router
322 TCP/IP data
323 Buffering and re-clocking device
324 Data transceiver
325 Data connector
330 Internet card (second instance)
331 Packet router
332 TCP/IP data
333 Buffering and re-clocking device
334 Data transceiver
335 Data connector
340 Fixed telephony card
341 Packet router
342 Input data
343 Output data
344 Buffering and re-clocking device
345 Buffering and re-clocking device
346 Digital to analog converter
347 Analog to digital converter
348 Telephony hybrid
349 Level converter
350 Telephone connector
360 Bluetooth card for handset and remote control unit
361 Packet router (telephony)
362 Packet router (remote control unit)
363 Incoming and outgoing telephony (digitized)
364 Incoming data and commands relevant to remote control unit
365 Outgoing data and commands relevant to remote control unit
366 Buffering and re-clocking device
367 Main processor for data and commands relevant to remote control unit
368 Multiplexer/demultiplexer
369 Station memory
370 Keypad, display and beep
371 Bluetooth transceiver
372 Bluetooth antenna
375 Radio modem
376 Wireless link carrying channels for multiple users
377 Antenna external to vehicle
378 Vehicle
379 Group repeater
380 Antenna inside passenger compartment
381 Passenger compartment
382 Bluetooth radio links
383 Handsets
385 Repeater section (one per user)
386 Antenna splitter/combiner
387 To diplexers (388) in other repeater sections
388 Diplexer
389 Bandwidth control
390 Receiver
391 Transmitter
392 Receive local oscillator signal
393 Transmit local oscillator signal
394 Frequency generator
395 Receive baseband modem
396 Transmit baseband modem
397 CDMA spreading code
398 Encryption and decryption key
399 Encryption and decryption device
400 Programmable logic device or other processing device
401 Bluetooth transceiver
402 Receive and transmit buffers
403 To Bluetooth transceivers (401) in other repeater sections
404 Antenna splitter/combiner
406 Control bus
407 To programmable logic or other processing devices (400) in other sections
408 System controller (shared)
409 Code pool (shared)
415 To satellite transceiver located at gateway (6)
416 Satellite antenna
417 Satellite transponder or transponders
418 Satellite links
419 Private facility
420 Ultra-high frequency wireless link
421 Medium-range handsets
422 High-frequency or ultra-high frequency wireless links
423 Long-range vehicle units
424 Long-range handsets
425 Remote area
426 Relay site for itinerant users (shared)
427 Itinerant users
428 Aircraft
430 Satellite antenna
431 Satellite transceiver
432 High-speed data bus
433 Set-top-box antenna
434 Low power radio links (VHF FM and UHF TV)
435 External radio receiver
436 External TV receiver
437 Long-range set-top-box
438 External radio receiver or other sound equipment
439 External TV receiver or other audio/visual equipment
440 External computer
441 External fixed telephony or facsimile equipment
442 Low-level radio frequency or audio signal
443 Low-level signal (audio/visual or modulated radio frequency)
444 Data connection
445 Telephone conductor
446 Remote control unit or units
447 Bluetooth wireless links
448 User's radio and TV antennas
449 Long-range transceiver
450 Same as (449)
451 Local transceiver
452 Bus extender
453 Medium-range handset
454 Ultra-high frequency radio links
455 Medium power high-frequency or ultra-high frequency wireless links
456 Long-range handset
457 Long-range vehicle unit
458 Bluetooth or ultra-high frequency wireless link
459 To second long-range set-top-box (if used)
467 Digital encryption/decryption device
468 Ultra-high frequency duplex transceiver
469 Transmit/receive diplexer
470 Ultra-high frequency antenna
471 Antenna tuning unit control line
472 To high-frequency antenna via antenna tuning unit (493)
473 Removable front panel
474 Audio signal switch
475 Central processor
476 High-speed data input/output port
477 Analog encryption/decryption device (A5 telephony or equivalent)
478 Digital to analog and analog to digital converter (part of quasi-duplex sub-system described herein)
479 Decoder for alert signals and incoming system commands
480 Analog encryption and decryption device (part of quasi-duplex sub-system described herein)
481 Timing signal
482 Block time compandor (part of quasi-duplex sub-system as described herein)
483 High-frequency simplex transceiver
484 Signal strength data and channel requests
485 System commands including mode, channel frequency, encryption level.
490 Additional items to convert standard vehicle unit to long-range vehicle unit
491 High-frequency vehicular antenna
492 High-frequency signals (transmit); medium frequency and very high frequency signals (receive)
493 Antenna tuning unit
494 High-frequency signals
495 Medium and very-high frequency signals
496 Ultra-high frequency vehicular antenna
497 Long-range adaptor
498 High-speed data bus
499 Low-level signal (audio or modulated radio frequency)
500 External receiver, speakers, or other audio equipment
506 High-speed data bus
507 Circuit blocks similar to local transceiver (451)
508 Digital encryption/decryption device
509 Ultra-high frequency duplex transceiver
510 Transmit/receive diplexer
511 Diplexer
512 Ultra-high frequency antenna
513 Antenna tuning unit control line
514 To high-frequency antenna via antenna tuning unit (493)
515 Circuit blocks similar to long-range transceiver (449)
516 Digital encryption/decryption device
517 Ultra-high frequency duplex transceiver
518 Transmit/receive diplexer
519 High-speed data input/output port
520 Audio signal switch
521 Central processor
522 Encryption device (A5 telephony or equivalent algorithm)
523 Digital to analog and analog to digital converter (part of quasi-duplex sub-system described herein)
524 Decoder for alert signals and incoming system commands
525 Analog encryption and decryption device (part of quasi-duplex sub-system described herein)
526 Timing signal
527 Block time compandor (part of quasi-duplex sub-system described herein)
528 High-frequency simplex transceiver
529 Signal strength data and channel requests
530 System commands including mode, channel frequency, encryption level.
535 Low-loss cable to high-frequency antenna (491)
536 Input connector
539 To long-range adaptor (490)
540 High-frequency bandstop filter
541 Frequency splitting network
542 Control signals
543 Status signals
544 Directional coupler
545 Central processor
546 Matching network
547 Non-volatile memory
550 Satellite antenna
551 Satellite transceiver (not required if services are obtained from (557))
552 System controller
553 Long-range transceiver (449)
554 Same as (553)
555 Same as (553)
556 Same as (553)
557 Optical fiber or other broadband trunk from gateway (6) (if available at this location)
558 Modem (not required if services are obtained from (418))
559 Antenna combiners (ultra-high frequency and high-frequency)
560 Ultra-high frequency antenna
561 High-frequency receive antenna
562 High-frequency transmit antenna
563 Ultra-high frequency and high-frequency wireless links
564 Long-range vehicle unit
565 Long-range handset
570 Satellite antenna
571 Satellite transceiver (not required if services obtained from (578))
572 System controller
573 Long-range transceiver (449) (receiver section not required)
574 Same as (573)
575 Same as (573)
576 Same as (573)
577 Bus extender
578 Optical fiber or other broadband trunk from gateway (6) (if available at this location)
579 Modem (not required if services are obtained from (418))
580 Antenna combiners (ultra-high frequency and high-frequency)
581 Ultra-high frequency antenna
582 High-frequency transmit antenna
583 Ultra-high frequency and high-frequency wireless links
584 Ultra-high frequency wireless link
585 High-frequency receive site
586 Bus extender
587 System controller
588 Long-range transceiver (449) (transmitter section not required)
589 Same as (588)
590 Same as (588)
591 Same as (588)
592 High-frequency antenna splitter
593 High-frequency antenna
594 Long-range vehicle units
595 Long-range handset
596 High-frequency wireless receive links
600 Satellite transceiver
601 Satellite antenna
602 Satellite links
603 Satellite transponder
604 Satellite antenna (aircraft mounted)
605 Satellite transceiver
606 Group repeater
607 Bluetooth wireless link
608 Passenger compartment
609 Handsets
610 Aircraft skin
   NOT USED (Informative):
12-13; 43-49; 64; 73-79; 92; 102; 105-109; 152-159; 165-169; 205-209; 233-237; 253-259; 273-279; 293-299; 313-319; 326-329; 336-339; 351-359; 373-374; 384; 405; 410-414; 429; 460-466; 486-489; 501-505; 531-534; 537-538; 548-549; 566-569; 597-599

1. A system for delivering broadcast and communications services through a connection system to fixed, vehicular and portable recipients, wherein said services comprise provision of one or more Internet media streams comprising Internet audio streams and Internet video streams, Internet data comprising the world-wide-web and email, and telecommunications; the system comprising one or more gateways which provide connections to external communications networks and nodes and internal loopbacks from which said services are obtained, each of said one or more gateways comprising:
(a) a selection system to selectively establish communication channels with said external communication nodes networks and preferably said loopbacks to establish an individual bidirectional channel between each said node network and allow recipients to obtain the communication channel of their choice;
(b) a processing system comprising non-blocking matrix switching or routing system, buffering, packeting, and addressing systems; processing said channels containing said services into digitised packaged data format and said addressing systems identifying, storing and updating in real time the location of each recipient, whether fixed, vehicular or portable, and applying routing information to each packet of said digitised packaged data to enable said packets to be correctly routed through the system to reach each recipient.

2. The system as defined in claim 1 further comprising a multiplexing system wherein said packets for multiple recipients are combined together to enable said packets to be conveyed to recipients using a connection system, said packets remaining identifiably separate from each other and being routed to each said recipient according to the routing information contained in or applying to each said packet.

3. The system as defined in claim 1 wherein there is a plurality of gateways and the system allows connection between said gateways to share the load and introduce redundancy.

4. The system as defined in claim 1 including a splitting means connected with at least one of said connection means and able to split said Internet media streams or data or packets derived therefrom into as many duplicates as necessary to satisfy the number of recipients for each said stream.

5. The system as defined in claim 1, wherein the one or more gateways include repository means for storing system software required by downstream devices, and enabling downloading of said system software to said devices to remotely refresh or upgrade said downstream devices.

6. The system as defined in claim 1 including channel optimization means for gathering and processing real-time or near real-time ionospheric propagation data, automatically determining suitable channels for high frequency radio links used by this system, and managing said channels to maximize the quality of service and efficiency of spectrum utilization by remotely controlling transmitter frequencies, powers and other parameters used by the equipment providing said high frequency links.

7. The system as defined in claim 1 wherein gateways include monitoring means for collating the time of day and day of the week when particular Internet media streams are requested, and using fuzzy logic as a means of prediction, for the selection means to open an individual bidirectional channel with one of said external communications node or network from which said stream is obtainable in advance of the predicted likely time of request to eliminate or minimize the time required to establish said stream with said external source.

8. The system as defined in claim 1, wherein the connection means for connecting recipients to processing means includes any combination of a plurality of optical fiber, hybrid-fiber coax, coaxial or other cable, satellite relay links, wideband radio links, and narrowband radio links, and further that said connection means for connecting recipients includes all necessary routing, multiplexing and demultiplexing, signal regeneration, radio transmission and reception, automatic link establishment, and means of duplex or quasi-duplex operation and further that said connection means also allows digitized packaged data to be conveyed from each recipient to the gateway as required.

9. The system as defined in claim 1, wherein the connection means for connection to vehicular and portable recipients is provided by short-range radio modems, said modems placed at regular intervals around the localities where wireless connections to vehicular and portable recipients are to be provided, said modems including means of a multi-access technique to enable said modems to establish individual wireless connections with multiple recipients.

10. The system as defined in 1, wherein the connection means for connection to vehicular and portable recipients is provided by transponders, said transponders providing a means of decoding Internet media streams, modulating same onto individual radio-frequency carriers of appropriate frequency, and transmitting said modulated carriers to one or more recipients within range of said transponder, said transponders including means of sending information containing the frequency of requested streams to a radio modem near the requester of that stream, said modem passing said frequency information to the requestor's equipment causing automatic tuning to the stream on said radio frequency and receipt of said transmitted stream.

11. The system as defined in any one of claim 1 having a method of quasi-duplex communication of a signal on a single narrowband radio channel wherein the receiving party is able to break-in on the transmitting party at any time, and including the features of:
(a) a radio link connectable between two stations herein called ‘A’ and ‘B’;
(b) the signal to be modulated is in analogue or digital format;
(c) at station ‘A’, the signal to be modulated is sampled and formed into blocks of fixed duration;
(d) at station ‘A’, the blocks are individually re-clocked to slightly speed them up, to produce blocks of shorter duration with gaps in between;
(e) at station ‘A’, the re-clocked blocks are converted to analogue and transmitted, such that transmissions comprise periods of signal interspersed with short periods of silence at regular intervals;
(f) during the periods of silence, station ‘A’ switches to receive and listens for a transmission from station ‘B’;
(g) if station ‘B’ wishes to break in, it transmits an interrupt code during a silent period of station ‘A’, said interrupt code comprising an easily recognised signal such as parallel audio tones;
(h) if station ‘A’ hears an interrupt code during a silent period, it temporarily pauses transmission and attempts to perform a handshake with station ‘B’ to check the validity of the interrupt;
(i) if handshaking confirms the interrupt to be valid, station ‘A’ ceases transmission, discards further blocks, and listens for station ‘B’ to transmit;
(j) if the interrupt is found to be false, after a designated period of time station ‘A’ reverts to the regular transmission of blocks;
(k) at station ‘B’, the signals from station ‘A’ are received, demodulated, and sampled;
(l) at station ‘B’, the sampled received signal is re-clocked to slow it down by the same amount by which it was originally sped up, such that the gaps between blocks are caused to exactly disappear, and the signal is restored to a similar waveform to that initially applied to station ‘A’;
(m) stations ‘A’ and ‘B’ can swap roles at any time;
(n) contention is avoided if stations ‘A’ and ‘B’ are synchronised such that their silent periods alternate and are approximately equally spaced;
(o) during extended transmissions, stations ‘A’ and ‘B’ may periodically interrupt each other to confirm that the channel is still open and the traffic is valid.

12. The system as defined in claim 1 including portable modems wherein vehicular and portable recipients are able to be wirelessly connected by short-range radio, said portable modems including:
(a) storage means for inputting and receiving and storing and editing URLs for said broadcast and communications services;
(b) input means which in response to an action performed by the recipient, recalls from memory the URL of a desired Internet media stream and sends the URL to the gateway to cause said stream to be obtained by the gateway and delivered to said recipient via the connection means;
(c) converting means able to convert packets received from said gateway to an analogue or digital baseband signal, and performing all necessary processing and amplification to enable same to drive an internal or external audio or video transducer or other external equipment.

13. A portable modem for use by vehicular or portable recipients which enable wireless connection to fixed short-range radio modems for delivering broadcast and communications services including provision of one or more Internet media streams, Internet audio streams and Internet video streams, Internet data, the world-wide-web and email, and telecommunications and for connection to one or more gateways which provide connections to external communications networks and nodes and internal loopbacks from which said services are obtained, said portable modems including:
(a) storage means for inputting and receiving and storing and editing URLs for said broadcast and communications services;
(b) input means which in response to an action performed by the recipient, recalls from memory the URL of a desired Internet media stream and sends the URL to the gateway to cause said stream to be obtained by the gateway and delivered to said recipient via the short range radio modem;
(c) converting means able to convert packets received from said radio modem to an analogue or digital baseband signal, and performing all necessary processing and amplification to enable same to drive an internal or external audio or video transducer or other external equipment.

14. The portable modem as defined in claim 13, including receiving means for receiving signals on free-to-air radio or television frequencies, demodulating said signals to an analogue or digital baseband signal, and performing all necessary processing and amplification to enable same to drive an internal or external audio or video transducer or other external equipment.

15. The portable modem as defined in claim 13, including modulation means to modulate an analogue or digital baseband signal obtained from an Internet media stream or a free-to-air station onto a radio-frequency carrier of appropriate frequency for reception by an external receiver tuned to the same frequency.

16. The portable modem as defined in claim 13 including a means of making and receiving telephone calls through short-range radio modems.

17. The portable modem as defined in claim 13 including a means of establishing a Bluetooth short-range wireless link with a portable handset enabling the user to make and receive telephone calls using said handset.

18. The portable modem as defined in claim 13 including a means of establishing a Bluetooth short-range wireless link with a portable handset enabling the user to select a desired Internet media stream or station and function as a portable listening device for said stream or station.

19. The portable modem as defined in claim 13, including a means of accessing the Internet including the world-wide-web and email through said short-range radio modems.

20. The portable modem as defined in claim 13 including connection to an external computer, enabling a user of said computer to access the Internet including the world-wide-web and email through said modem.

21. The portable modem as defined in claim 13 including a connection means to an external computer wherein said computer is able to function as an additional front panel for said modem.

22. The portable modem as defined in claim 13 including a means of monitoring the power drain of external equipment such as a radio receiver, such that if said external equipment is switched on or off, said modem will automatically switch on or off in unison.

23. The system as defined in claim 10, wherein portable modems include a means of very-high frequency or ultra-high frequency radio transmission and reception including antenna means, to enable the means of connection to be completed using a single-user point-to-point radio link if no other path is available, and operating duplex or quasi-duplex and employing means of automatic link establishment.

24. The system as defined in claim 10, wherein portable modems include a means of high frequency radio transmission and reception including antenna and antenna tuning means, to enable the means of connection to be completed using a single-user high frequency point-to-point radio link if no other path is available, and operating duplex or quasi-duplex and employing means of automatic link establishment.

25. The system as defined in claim 1, which includes a relay means for relaying a group of bidirectional channels from one or more nearby radio modems to multiple recipients located inside a shared space such as commuter vehicle, wherein:
(a) recipients are using handsets;
(b) the connections to said handsets are made using a shared multi-access technique such as Bluetooth;
(c) to the extent allowed by the handsets, recipients are able to independently access the service of their choice, including the ability to make and receive telephone calls, the ability to select and listen to Internet media streams, and the ability to connect a portable computer to their handset and access the Internet including the world-wide-web and email through said handset.

26. The system as defined in claim 23, wherein the group of channels is obtained from a satellite relay link in lieu of nearby radio modems and the recipients are located on board an aircraft.

27. The system as defined in claim 1 wherein the connection means for connecting recipients at fixed locations is provided by modems which receive packets from the connection means and converts said packets into a form which is recognized by a set-top-box, said set-top-box functioning as a hub for the recipient's external media, computing and telecommunications equipment, wherein it provides a means of converting Internet media streams to analogue or digital baseband signals as appropriate, and also performing all necessary processing and amplification to enable same to either drive the recipient's external media equipment through wires, or else to be modulated onto a radio-frequency carrier of suitable frequency and transmitted wirelessly for reception by said equipment on the same frequency.

28. A set-top-box for connection to recipients at fixed locations by modems for delivering broadcast and communications services including provision of one or more Internet media streams, Internet audio streams, Internet video streams, Internet data, the world-wide-web and email, and telecommunications; and connecting to one or more gateways which provide connections to external communications networks and nodes and internal loopbacks from which said services are obtained, said set-top-box including receiving means which receives packets of said services processed into digitized packaged data format from a connection means and converts said packets into a useable form for said set-top-box to function as a hub for the recipient's external media, computing and telecommunications equipment, wherein the set-top-box provides a means of converting Internet media streams to analogue or digital baseband signals as appropriate, and also performing all necessary processing and amplification to enable same to either drive the recipient's external media equipment through wires, or else to be modulated onto a radio-frequency carrier of suitable frequency and transmitted wirelessly for reception by said equipment on the same frequency.

29. The set-top-box according to claim 27 including receiver means for receiving signals on free-to-air radio or television frequencies, demodulating them to analogue or digital baseband signals as appropriate, and performing all necessary processing and amplification to enable driving of the recipient's external media equipment through wires, or to be modulated onto a radio-frequency carrier of suitable frequency and transmitting wirelessly for reception by said equipment on the same frequency.

30. The set-top-box as defined in claim 27, wherein the set-top-box includes means of connection to an external computer to enable it to access the Internet including the world-wide-web and email through said set-top-box.

31. The set-top-box as defined in claim 27 wherein the set-top-box includes a means of physical connection to an external telephone to enable it to make and receive telephone calls through said set-top-box.

32. The set-top-box as defined in claim 27 including a means of establishing a Bluetooth wireless link with a portable handset to enable the user to make and receive telephone calls through said set-top-box.

33. The set-top-box as defined in claim 27 including a means of establishing a Bluetooth wireless link with one or more remote control units to enable the user to control the selection of Internet media streams and free-to-air stations delivered to the recipient's external media equipment.

34. The set-top-box as defined in claim 27 including a means of requesting information from one of the gateways and downloading received information to the recipient's remote control units, to enable the recipient's external media equipment to be correctly controlled through the infrared links of said equipment.

35. The set-top-box for use in a system as defined in claim 23 the set-top-box including receiver means enabling services to be obtained from a satellite relay link, and to direct said services to a means of radio transmission and reception, said means of transmission and reception providing the means to forward said services to an outlying recipient using a high-frequency or ultra-high frequency radio link.

36. The set-top-box as defined in claim 27 including remote control units able to transmit commands using both Bluetooth and infrared, to enable said units to control the recipient's external media equipment separately from the set-top-box.

37. The system as defined in claim 1, including remote control units having a means of being associated with more than one type of external media equipment, and being able to be quickly and easily switched between infrared command sets applicable to each type of said equipment.

38. The system as defined in claim 36, wherein said remote control units include a means of storing combinations of commands that are retrieved and transmitted as a group.

39. The set-top-box as defined in claim 27, which includes a means for the recipient to store information and notes on program or content, and to send an order via the means of connection to purchase items heard or viewed using said set-top-box or a device which is receiving said program or content from said set-top-box.

40. The handset as defined in claim 17, which includes a means for the recipient to store information and notes on program or content, and to send an order via the means of connection to purchase items heard or viewed using said handset.

41. The portable modem as defined in claim 13, which includes a means for the recipient to store information and notes on program or content, and to send an order via the means of connection to purchase items heard or viewed using said portable modem.

42. The system as defined in claim 1, which includes one or more means of receiving services from a modem or satellite relay link, said means being spatially arranged in a grid or other suitable pattern across the area to be covered, said means being able to relay services to multiple recipients using any suitable frequency including high-frequency and ultra-high frequency radio links, said radio links operating duplex or quasi-duplex and employing means of automatic link establishment.
